(19) United States
(12) Patent Application Publication
(10) Pub. No.: US 2025/0278844 A1
(43) Pub. Date: Sep. 4, 2025

(54) Systems And Methods For Tracking Persons In An Environment

(71) Applicant: Sony Electronics Inc., San Diego, CA (US)

(72) Inventors: Nitish Agarwal, Boca Raton, FL (US); Steven Cadavid, Boca Raton, FL (US)

(21) Appl. No.: 18/823,975

(22) Filed: Sep. 4, 2024

Related U.S. Application Data
(60) Provisional application No. 63/559,330, filed on Feb. 29, 2024.

(51) Int. Cl. G06T 7/292; G06T 7/246; G06V 10/26; G06V 10/762; G06V 10/82; G06V 20/40

(52) U.S. Cl. CPC G06T 7/292; G06T 7/246; G06V 10/26; G06V 10/762; G06V 10/82; G06V 20/42; G06T 2207/10016; G06T 2207/20084; G06T 2207/30196; G06T 2207/30221

(57) ABSTRACT

Disclosed embodiments include: (A) obtaining a plurality of camera views from a plurality of cameras configured to obtain frames of video data containing persons within an environment; (B) for each camera view, (i) detecting persons within the camera view by processing the video data from the individual camera via a neural network, and (ii) generating a bounding box for each detected person; (C) generating sets of associated bounding boxes, each set includes multiple bounding boxes from multiple different camera views that correspond to the same detected person; and (D) for each of a plurality of timeframes, (i) generating a cuboid for each set of associated bounding boxes, and (ii) for each cuboid, associating the cuboid with one of a plurality of tracklets based on (a) a position of the cuboid during the timeframe and (b) predicted future positions for each of the plurality of tracklets for the timeframe.

### CROSS-REFERENCE TO RELATED APPLICATIONS

The present application claims priority to U.S. Prov. App. 63/559,330 titled “Systems And Methods For On-Field Player Position Tracking,” filed on Feb. 29, 2024, and currently pending. The entire contents of U.S. Prov. App. 63/559,330 are incorporated herein by reference.

### FIELD

The systems and methods disclosed and described herein relate to tracking persons and objects within an environment based on video data obtained from a plurality of cameras configured to obtain frames of video data of the environment from multiple different perspectives. In some embodiments, the environment is a sports or athletic environment, and the persons in the environment include players of the sport and/or other participants in or spectators of the sporting activity. In some embodiments, the disclosed systems and methods track positions of players and/or objects (e.g., balls) on a playing field.

### SUMMARY

Disclosed embodiments include systems and methods that use computer vision and machine learning techniques to track persons through time based on a multi-camera array positioned around and aimed at an environment, or at least a substantial portion of the environment. In some example embodiments described herein, the environment includes a sports environment (e.g., a baseball field or other sports environment), and the persons include players, coaches, umpires or referees, or other persons who may be within the sports environment.

In operation, frames of camera data from each camera are fed into a neural network (e.g., a single-stage anchor-free object detector) that is configured to detect persons within the environment, and in some instances generate bounding boxes around each detected person. The generated bounding boxes from each of the cameras are then aggregated together to form bounding cuboids via a novel integration technique based at least in part on bi-partite graph assignment. In some embodiments, the bi-partite graph assignment employs a hierarchical Hungarian Algorithm approach. The bounding cuboids are tracked through time, and cuboids within close proximity to each other can be disambiguated with bi-partite graph assignment and tracked and/or smoothed using Kalman filtering techniques. Some embodiments additionally include assigning roles to detected persons (e.g., players) based on their positions within the environment, including based on their initial positions within the environment.

Some embodiments include, among other features: (A) obtaining a plurality of camera views from a corresponding plurality of cameras positioned at different locations around the environment and configured to obtain frames of video data containing persons within the environment; (B) for each camera view obtained from an individual camera, (i) detecting one or more persons within the camera view by processing the video data from the individual camera via a neural network, and (ii) generating a bounding box for each person detected in the camera view; (C) generating one or more sets of associated bounding boxes, wherein each set of associated bounding boxes includes two or more bounding boxes from two or more different camera views that correspond to a same person detected in the different camera views; and (D) for each timeframe of a plurality of timeframes, (i) generating a bounding cuboid for each set of associated bounding boxes for the timeframe, and (ii) for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views.

Some embodiments additionally or alternatively include tracking one or more objects within the environment. In some embodiments where the environment is a sports environment as mentioned above, the objects include one or more balls within the sports environment. Some such embodiments include, among other features, for each detected object (e.g., a ball) that has been detected by the plurality of cameras positioned around the environment: (A) generating a point cloud that includes a plurality of points, wherein each point of the plurality of points corresponds to a point in space where two rays projected from two of the plurality of cameras intersect in space at the detected object; (B) creating a selected subset of the plurality of points, wherein the selected subset of the plurality of points includes points that are within a threshold distance of a threshold number of other points of the plurality of points; (C) generating a cuboid associated with the detected object, wherein the cuboid is based on a centroid of the points in the selected subset of points; and (D) matching the generated cuboid associated with the detected object with one of a plurality of object tracklets, wherein each object tracklet corresponds to a tracked object within the environment, and wherein matching the generated cuboid associated with the detected object with one of the plurality of object tracklets is based on distances between (i) a position of a centroid of the generated cuboid associated with the detected object, and (ii) positions of predicted centroids for each object tracklet in the plurality of object tracklets.

Certain examples described herein may include none, some, or all of the above described features and/or advantages. Further, additional features and/or advantages may be readily apparent to persons of ordinary skill in the art based on reading the figures, descriptions, and claims included herein.

Further, the systems and methods described herein, and the individual features thereof, are modular and can be performed in various combinations to suit specific needs. Not all embodiments necessitate the implementation of every feature outlined. This modularity of the disclosed embodiments allows for flexibility and customization during deployment in different environments. While many of the examples are described with reference to baseball to aid in providing a concrete, understandable use case, the underlying principles and features of the disclosed embodiments are equally applicable to a wide range of other sports environments as well as other non-sports environments.

### BRIEF DESCRIPTION OF THE FIGURES

For a more complete understanding of the present disclosure and its features and advantages, reference is now made to the following description, taken in conjunction with the accompanying figures.

FIG. 1 shows aspects of an example environment with a plurality of cameras positioned around the environment according to some embodiments.

FIG. 2 shows aspects of generating a single bounding box around each detected person within a single camera view comprising a set of bounding boxes according to some embodiments.

FIG. 3A shows aspects of generating a set of associated bounding boxes from multiple different camera views according to some embodiments.

FIG. 3B shows aspects of generating a set of associated bounding boxes from multiple different camera views according to some embodiments.

FIG. 3C shows aspects of generating a set of associated bounding boxes from multiple different camera views according to some embodiments.

FIG. 4 shows aspects of generating a bounding cuboid for a set of associated bounding boxes according to some embodiments.

FIG. 5 shows aspects of associating generated bounding cuboids with tracklets corresponding to persons according to some embodiments.

FIG. 6A shows aspects of an example method for tracking persons in an environment according to some embodiments.

FIG. 6B shows aspects of an example method for tracking objects in an environment according to some embodiments.

FIG. 7 shows aspects of an example computing system configured to perform aspects of the disclosed methods and variations thereupon according to some embodiments.

### DETAILED DESCRIPTION OF THE FIGURES

The following disclosure makes reference to the accompanying figures and several example embodiments. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example Environment with Cameras Arranged to Obtain Camera Views

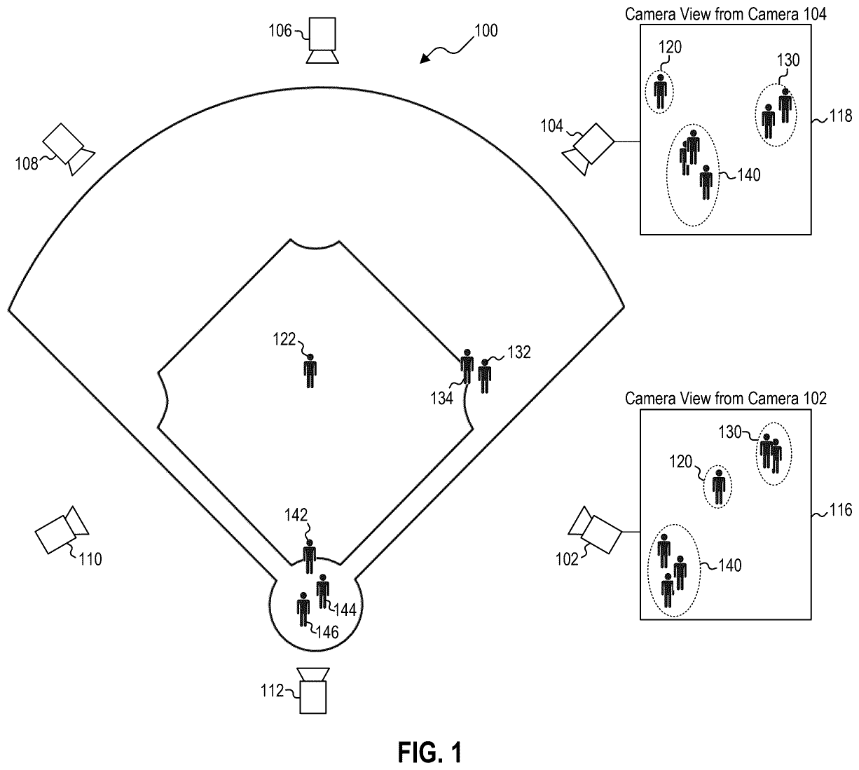

FIG. 1 shows aspects of an example environment 100 with a plurality of cameras 102-112 positioned around the environment 100 according to some embodiments.

In the example of FIG. 1, the environment 100 is depicted as a baseball field. However, the environment may be any other type of environment where a plurality of cameras can be configured to capture different camera views of the environment, including other types of sporting/athletic environments (e.g., a basketball court, football field, soccer field, tennis court, swimming pool, athletic practice facility, and so on), airports, train stations, parking lots, shopping malls, warehouses, manufacturing facilities, homes, offices, or any other type of environment in which it may be desirable to track the positions of persons therein.

Within the context of the baseball field depicted in the example environment 100, the plurality of cameras includes camera 102 positioned near the first base line, camera 104 positioned near right field, camera 106 positioned near center field, camera 108 positioned near left field, camera 110 positioned near the third base line, and camera 112 positioned near home plate.

Other embodiments may include more cameras or fewer cameras than the cameras shown in the example environment 100 in FIG. 1. For instance, some embodiments where the environment 100 is a baseball field may include more cameras positioned in additional locations around the baseball field. Similarly, some embodiments where the environment 100 is different than a baseball field may have more cameras or fewer cameras than the example environment 100 depicted in FIG. 1. In some embodiments, the number and arrangement of cameras is sufficient to obtain camera views from multiple vantage points of substantially all of the environment in which persons are to be tracked.

Each camera in the plurality of cameras is configured to obtain frames of video data containing the persons in environment 100, including person 122 near the pitcher's mound, persons 132 and 134 near first base, and persons 142, 144, and 146 near home plate.

Because the cameras are located at different positions around the environment 100, each camera obtains a different camera view of the environment 100. For example, camera 102 is arranged to obtain camera view 116, and camera 104 is arranged to obtain camera view 118. Although example environment 100 depicted in FIG. 1 shows only two camera views (i.e., camera view 116 and camera view 118), each other camera is also arranged to obtain a separate corresponding camera view as well.

Camera view 116 obtained from camera 102 shows three groups of persons: (i) group 120 includes person 122, (ii) group 130 includes persons 132 and 134, and (iii) group 140 includes persons 142, 144, and 146. Camera view 118 from camera 104 also shows three groups of persons: (i) group 120 with person 122, (ii) group 130 with persons 132 and 134, and (iii) group 140 with persons 142, 144, and 146. However, the arrangement of the groups 120, 130, and 140 of persons in camera view 116 is different than the arrangement of the groups 120, 130, and 140 of persons in camera view 118 because the camera 102 is at a different location and orientation as compared to camera 104.

For example, in camera view 116, group 140 is the left-most group within the camera view 116, group 120 is in the middle of the camera view 116, and group 130 is the right-most group in the camera view 116. Whereas, in camera view 118, group 120 is the left-most group in camera view 118, group 140 is in the middle of the camera view 118, and group 130 is the right-most group in camera view 118.

Further, the arrangements of the persons in the different groups is also different between camera view 116 and camera view 118 because of the different positions and orientations of cameras 102 and 104. For example, persons 132 and 134 in group 130 appear in different positions relative to each other within camera view 116 as compared to their positions relative to each other in camera view 118. Similarly, persons 142, 144, and 146 in group 140 appear in different positions relative to each other within camera view 116 as compared to their positions relative to each other in camera view 118.

Using several different cameras in different positions and orientations can provide a large of amount of video data from different viewing perspectives that can be used for tracking persons within the environment 100. Having more video data to use for tracking persons within the environment 100 can be better than having less data to use for tracking persons. However, positioning several cameras in different locations and at different orientations around the environment 100 in the manner shown in FIG. 1 introduces complex technical challenges with tracking persons within the environment because of how the same persons and groups of persons appear in different arrangements relative to each other within the different camera views. The technical difficulties grow as a function of the total number of cameras that are each generating different camera views from different perspectives because of each of the camera views is different.

The methods and procedures disclosed herein address the technical complexities arising as a result of the different camera views by, among other features: (1) for each camera view obtained from an individual camera, (i) detecting one or more persons within the camera view by processing the video data from the individual camera via a neural network, and (ii) generating a bounding box for each person detected in the camera view; (2) generating one or more sets of associated bounding boxes, where each set of associated bounding boxes includes two or more bounding boxes from two or more different camera views that correspond to the same person detected in the different camera views; and (3) for each timeframe of a plurality of timeframes, (i) generating a bounding cuboid for each set of associated bounding boxes for the timeframe, and (ii) for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, where each tracklet corresponds to a set of historical positions of one of the persons detected in the plurality of camera views. Each of the above-described features is described further in the following sections.

### II. Generating a Bounding Box for Each Detected Person

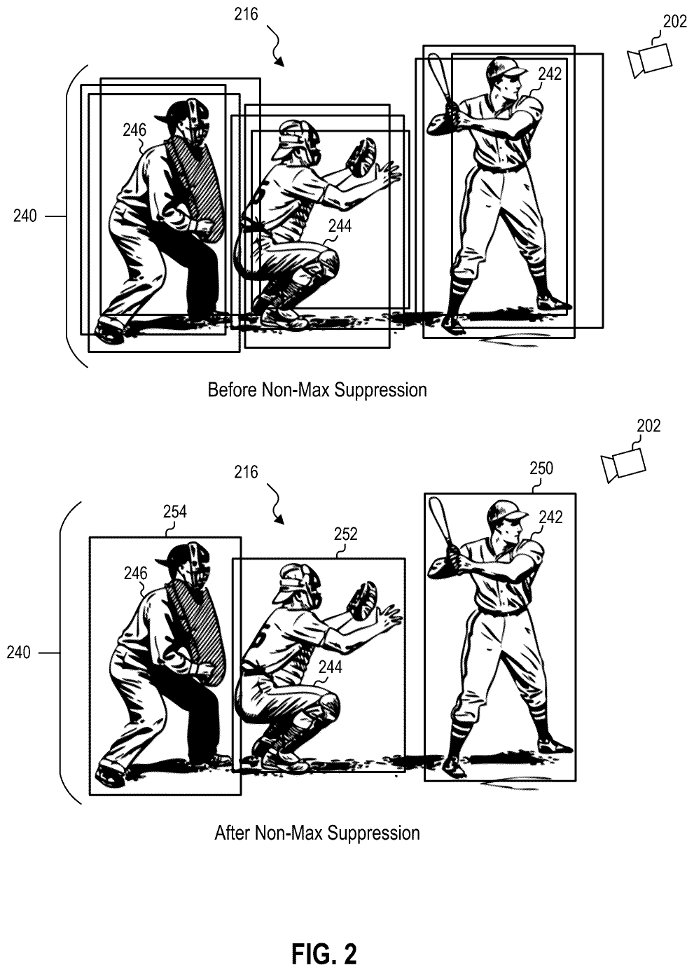

FIG. 2 shows aspects of generating a single bounding box around each detected person within a single camera view that includes a set of bounding boxes according to some embodiments.

In particular, the top half of FIG. 2 shows a camera view 216 obtained from camera 202 with a set of bounding boxes that includes several bounding boxes for each detected person. The camera 202 may be similar to or the same as camera 102 (FIG. 1), any other camera shown in FIG. 1, or any other camera suitable for obtaining frames of video data. The bottom half of FIG. 2 shows camera view 216 from camera 202 after selection of a single bounding box for each detected person.

The camera view 216 includes a group 240 of persons. The group 240 includes person 242, person 244, and person 246. The group 240 may be similar to or the same as group 140 (FIG. 1) or any other group of persons. In the example group 240 shown in example camera view 216 depicted in FIG. 2, person 242 is a batter, person 244 is a catcher, and person 246 is a home plate umpire. However, the particular roles of the persons in group 240 are for illustrative purposes only. Similarly, the processes for generating bounding boxes described in this section are equally applicable to groups containing more than three persons and/or fewer than three persons.

In operation, the camera view 216 obtained from camera 202 is provided to a neural network configured to detect persons. In some embodiments, the neural network comprises an anchor-free, single-stage object detector. In some embodiments, the neural network is configured to implement a You Only Look Once (YOLO) real-time object detection algorithm that uses a convolutional neural network to detect objects, including persons. Some embodiments include implementing one or more YOLO models via the Open Neural Network Exchange (ONNX), which is an open-source system for implementing machine learning models. However, any other suitable neural network in any other suitable configuration could be used to detect persons and generate bounding boxes.

In some embodiments, detecting the persons 242, 244, and 246 within the camera view 216 includes, for frames of video data obtained from the individual camera 202, (i) generating input tensor data based on an anchor frame selected from the frames of video data obtained from the individual camera 202, (ii) detecting the persons 242, 244, and 246 via the neural network based on the input tensor data, and (iii) generating output tensor data corresponding to each of the persons 242, 244, and 246 detected within the anchor frame of the frames of video data obtained from the camera 202.

In some embodiments, the disclosed systems and methods employ the same technique(s) to detect the persons appearing in each camera view obtained from each camera of the plurality of cameras positioned at the different locations around the environment. For example, with reference to FIG. 1, some disclosed embodiments employ the same (or substantially the same) procedure(s) to detect persons appearing in each camera view obtained from each of cameras 102-112 positioned at the different locations around environment 100. For instance, some disclosed embodiments include implementing the same detection procedures to detect the persons appearing in camera view 116 from camera 102 that are used to detect the persons appearing in camera view 118 from camera 104 (and each of the other camera views obtained from each of the other cameras 106-112).

Returning to FIG. 2, the disclosed embodiments include the above-described object detection algorithm generating a set of bounding boxes that includes several bounding boxes for each person detected within the camera view. For example, in camera view 216 shown in the top half of FIG. 2, the object detection algorithm has generated a set of bounding boxes that includes several bounding boxes for each detected person. Each bounding box generated by the object detection algorithm has a corresponding confidence score that corresponds to a level of confidence that the object detection algorithm has in how well the bounding box corresponds to the detected person. One aspect of the disclosed embodiments includes obtaining just a single bounding box for each detected person from this set of bounding boxes output from the object detection algorithm.

To obtain a single bounding box for each detected person from the set of bounding boxes, some embodiments include using a Non-max Suppression (NMS) filtering procedure with one of two different metrics (i.e., an Intersection over Union (IoU) metric and/or Intersection over Minimum Area (IoMA) metric, described below) to filter out (or reject) less ideal bounding boxes in favor of the best bounding boxes corresponding to each detected person. In operation, applying the Non-max Suppression (NMS) filtering procedure to the set of bounding boxes in the particular manner described herein removes duplicate bounding boxes corresponding to the same detected person when an object detection algorithm has generated multiple bounding boxes for the detected person.

Some embodiments employ NMS with an Intersection over Union (IoU) metric to the set of bounding boxes according to the following multi-step process.

Step 1: From the set of bounding boxes, select the bounding box having the highest confidence score assigned by the object detection algorithm.

Step 2: Set the highest-scoring bounding box from Step 1 as the bounding box for a detected person and remove this highest-scoring bounding box from the set of bounding boxes.

Step 3: Determine an Intersection over Union (IoU) value for each bounding box in the set of bounding boxes remaining after Step 2. For an individual bounding box in the set of bounding boxes, the IoU for the individual bounding box is equal to the area of the intersection between the highest-scoring bounding box and the individual bounding box divided by the union of the area of highest-scoring bounding box and the area the individual bounding box, as represented by the following equation:

$$IoU = \frac{Area ( Highest\_ScoringBox ) ⋂ Area ( Individual Box )}{Area ( Highest\_ScoringBox ) ⋃ Area ( Individual Box )}$$

Step 4: Discard every bounding box that has an IoU value above an IoU threshold from the set of bounding boxes.

Step 5: Keep every bounding box with an IoU value below the IoU threshold in the set of bounding boxes for further processing.

Step 6: If the set of bounding boxes still contains bounding boxes after Step 5, then return to Step 1 and apply the process again to the set of bounding boxes remaining in the set of bounding boxes after Step 5. Otherwise, end the non-max suppression procedure for the set of bounding boxes.

Implementing NMS with an Intersection over Union (IoU) metric according to the above described multi-step process removes the duplicate bounding boxes corresponding to the same detected person so that, after implementing the process, the set of bounding boxes includes a single bounding box for each detected person as shown in the bottom half of FIG. 2, where the set of bounding boxes includes (i) bounding box 250 corresponding to person 242, (ii) bounding box 252 corresponding to person 244, and (iii) bounding box 254 corresponding to person 246.

Some embodiments additionally or alternatively employ NMS with an Intersection over Minimum Area (IoMA) metric to the set of bounding boxes according to the following multi-step process.

Step 1: From the set of bounding boxes, select the bounding box having the highest confidence score assigned by the object detection algorithm.

Step 2: Set the highest-scoring bounding box from Step 1 as the bounding box for a detected person and remove this highest-scoring bounding box from the set of bounding boxes.

Step 3: Determine an Intersection over Minimum Area (IoMA) value for each bounding box in the set of bounding boxes remaining after Step 2. For an individual bounding box in the set of bounding boxes, the IoMA for the individual bounding box is the area of the intersection between the highest-scoring bounding box and the individual bounding box divided by the lesser of (i) the area of highest-scoring bounding box or (i) the area of the individual bounding box, as represented by the following equation.

$$IoMA = \frac{Area ( Highest\_ScoringBox ) ⋂ Area ( Individual Box )}{Min ( Area ( Highest\_ScoringBox ) , Area ( Individual Box ) )}$$

Step 4: Discard every bounding box that has an IoMA value above an IoMA threshold from the set of bounding boxes.

Step 5: Keep every bounding box with an IoMA value below the IoMA threshold in the set of bounding boxes.

Step 6: If the set of bounding boxes still contains bounding boxes after Step 5, then return to Step 1 and apply the process again to the set of bounding boxes remaining in the set of bounding boxes after Step 5. Otherwise, end the non-max suppression procedure for the set of bounding boxes.

Implementing NMS with an Intersection over Minimum Area (IoMA) metric according to the above described multi-step process removes the duplicate bounding boxes corresponding to the same detected person so that, after implementing the process, the set of bounding boxes includes a single bounding box for each detected person as shown in the bottom half of FIG. 2, where the set of bounding boxes includes (i) bounding box 250 corresponding to person 242, (ii) bounding box 252 corresponding to person 244, and (iii) bounding box 254 corresponding to person 246.

Some embodiments include implementing NMS with one of the Intersection over Union (IoU) metric or the Intersection over Minimum Area (IoMA) metric depending upon whether a camera view includes an object that at least partially obstructs the individual camera's view of the persons detected within the camera view. For example, in some embodiments where the environment is a sports or other athletic environment where the camera is configured to obtain a camera view of persons behind a net, a cage (e.g., a batting cage), or similar obstruction, implementing NMS with the Intersection over Minimum Area (IoMA) metric may provide better results than implementing NMS with the Intersection over Union (IoU) approach because of how netting or portions of a cage tend to break up the image of the detected person within the camera view.

Therefore, in some embodiments, generating one bounding box for each separate person detected in the camera view comprises: (A) when an individual camera view includes an object that at least partially obstructs the individual camera's view of the individual persons (e.g., contains a net, cage, or similar obstruction), and the individual camera view includes a set of bounding boxes comprising two or more bounding boxes surrounding at least a portion of the individual persons, implementing the above-described NMS process with the IoMA metric for the set of bounding boxes; and (B) when the individual camera view does not contain an object that at least partially obstructs the individual camera's view of the individual persons (e.g., does not contain a net, cage, or similar obstruction), and the individual camera view includes a set of bounding boxes comprising two or more bounding boxes surrounding at least a portion of the individual persons, implementing the above-described NMS process with the IoU metric for the set of bounding boxes.

In some embodiments, the object detection algorithm may be configured to determine whether an object (e.g., a net, cage, or similar obstruction) at least partially obstructs the camera's view of the person(s) within the camera view. Some such embodiments include applying the above-described NMS process with the IoMA metric to the set of bounding boxes in response to detecting that an object at least partially obstructing the camera's view of the person(s). Some such embodiments similarly include applying the above-described NMS process with the IoU metric to the set of bounding boxes in response to not detecting (or failing to detect) an object at least partially obstructing the camera's view of the person(s).

In some embodiments, the object (e.g., netting, a cage, or similar) may be expected to obstruct a particular camera's view of persons within the environment because of the position of the camera and the position of the object, particularly in circumstances where the object is not expected to move, which may be the case for a fixed baseball batting cage, or netting positioned behind the infield of a baseball field to protect spectators from foul balls. In some such embodiments, the disclosed systems and methods may be configured to apply the above-described NMS process with the IoMA metric to sets of bounding boxes within the camera views from each such camera where the object is expected to obstruct the camera's view.

### III. Generating a Set of Associated Bounding Boxes from Different Camera Views

When using bounding boxes in connection with tracking the positions of detected persons within an environment, it is advantageous to keep track of which bounding boxes correspond to which detected persons. However, because the same detected person (and that detected person's corresponding bounding box) may appear in different places within different camera views, it can be extraordinarily challenging to correlate (or associate) bounding boxes from multiple different camera views with the same detected person. This technical challenge increases with the total number of cameras and corresponding camera views, where each camera view may have several bounding boxes corresponding to several detected persons.

For example, in the scenario depicted in FIG. 1, there are six cameras positioned around the environment and configured to obtain six different camera views of the environment. When six different camera views each contain an image of the same detected person, then each camera view has a different bounding box for that detected person. And since each of the cameras is positioned in a different location around the environment, the arrangement of the detected persons (and their corresponding bounding boxes) in each camera view will be different because of the different positions of the different cameras relative to the detected persons.

For instance, recall that camera view 116 from camera 102 included (i) group 120, containing a single person, (ii) group 130 containing two persons, and (iii) group 140 containing three persons. Similarly, camera view 118 from camera 104 included (i) group 120, containing one person, (ii) group 130 containing two persons, and (iii) group 140 containing three persons. Although both cameras (camera 102 and camera 104) obtain corresponding camera views (camera view 116 and camera view 118, respectively) containing the same persons, the persons appear in different locations and orientations relative to each other in the two different camera views (camera view 116 and camera view 118) because of the different positions of the cameras (camera 102 and camera 104, respectively).

The disclosed embodiments solve several technical challenges associated with keeping track of which bounding boxes across the multiple camera views correspond to the same detected person by, among other features, generating one or more sets of associated bounding boxes, where each set of associated bounding boxes includes two or more bounding boxes from two or more different camera views that correspond to the same person detected in the different camera views. In some embodiments, generating one or more sets of associated bounding boxes includes, among of other features, for each bounding box in each camera view, generating a ground point for the bounding box that corresponds to a point on a ground plane of the environment where a ray projected from the camera that obtained the camera view intersects a midpoint along a bottom of the bounding box.

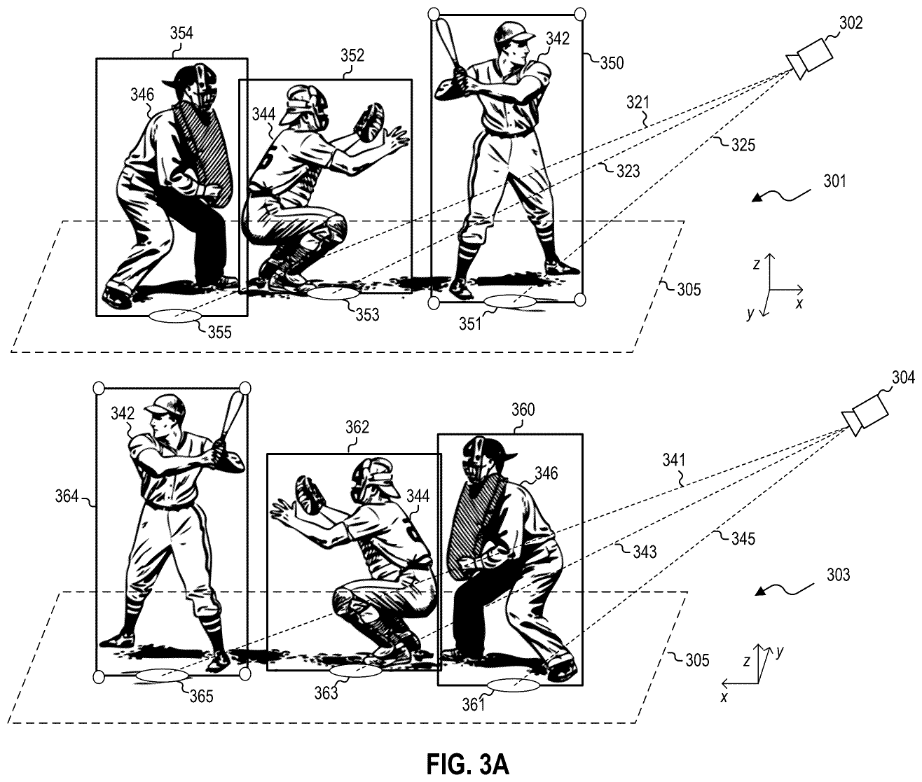

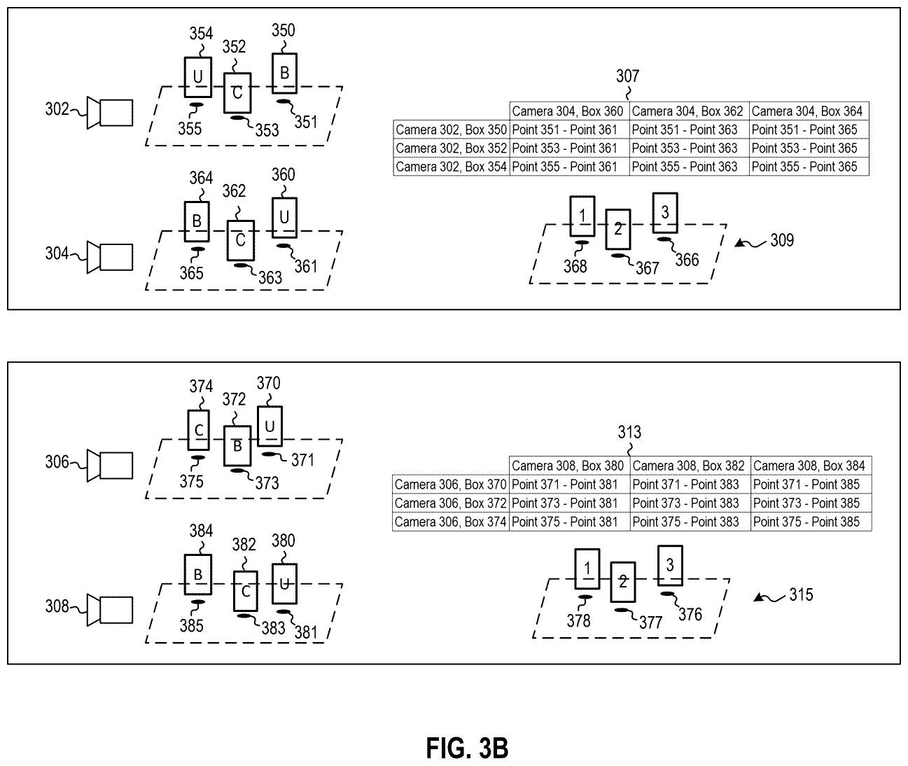

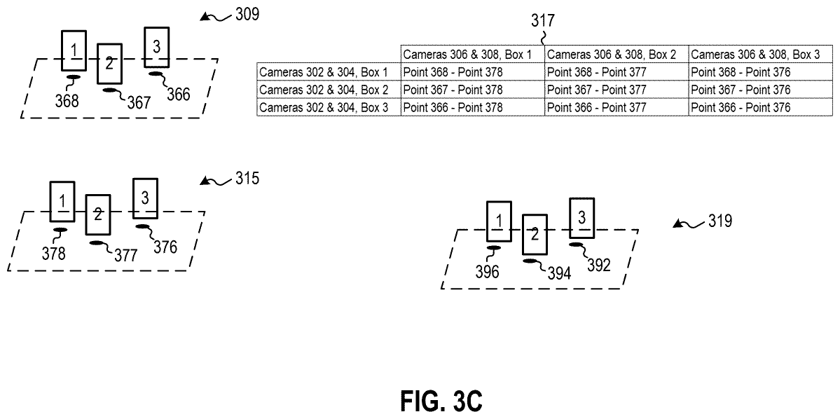

For example, FIG. 3A shows aspects of generating a set of associated bounding boxes from two different camera views (i.e., camera view 301 obtained from camera 302 and camera view 303 obtained from camera 304) based at least in part on ground points on the ground plane 305. Camera view 301 obtained from camera 302 generally corresponds to a view of home plate from near the first base line, and camera view 303 generally corresponds to a view of home plate from near the third base line. The arrangement of the persons depicted in camera views 301 and 303 are shown for illustration purposes to help explain aspects of associating bounding boxes from different camera views with each other and are not necessarily intended to correspond to specific cameras depicted in FIG. 1.

In camera view 301, person 342 (i.e., the batter) appears on the right side of the view, person 344 (i.e., the catcher) appears in the center of the view, and person 346 (i.e., the home plate umpire) appears on the left side of the view. After using one or more of the bounding box generation approaches described herein (e.g., the bounding box generation approaches described with reference to FIG. 2), (i) bounding box 350 corresponds to person 342 in camera view 301, (ii) bounding box 352 corresponds to person 344 in camera view 301, and (iii) bounding box 354 corresponds to person 346 in camera view 301. Each of the bounding boxes in camera view 301 has a ground point that corresponds to a point on the ground plane 305 of the environment where a ray projected from camera 302 intersects a midpoint along the bottom of the bounding box. For example, bounding box 350 has ground point 351 on ground plane 305 where ray 325 projected from camera 302 intersects a midpoint along the bottom of bounding box 350. Similarly, bounding box 352 has ground point 353 on ground plane 305 where ray 323 projected from camera 302 intersects a midpoint along the bottom of bounding box 352, and bounding box 354 has ground point 355 on ground plane 305 where ray 321 projected from camera 302 intersects a midpoint along the bottom of bounding box 354.

The same three persons appearing in camera view 301 also appear in camera view 303. However, the arrangement of those three persons in camera view 303 relative to each other is different than the arrangement of those three persons in camera view 301 relative to each other because camera 302 is in a different position around the environment than camera 304. In particular, in camera view 303, (i) person 342 (i.e., the batter) appears on the left side of the view rather than the right side of the view as in camera view 301, (ii) person 344 (i.e., the catcher) appears in the center of the view, and (iii) person 346 (i.e., the home plate umpire) appears on the right side of the view rather than the left side of the view as in camera view 301. For ease of illustration, FIG. 3A uses a mirror image of the same graphic to depict the different arrangement of the persons relative to each other in the different camera views from cameras 302 and 304. Persons of skill in the art should understand that the orientations of the persons in camera views 301 and 303 from cameras 302 and 304 would not be exact mirror images. Instead, since camera view 301 shows the front of the batter, then camera view 303 would in practice show the back of the batter rather than a mirror image. Nevertheless, the mirror images accurately illustrate how, across different camera views, the same detected person may appear in different positions relative to other persons within the camera views.

After using one or more of the bounding box generation approaches described herein, (i) bounding box 360 corresponds to person 346 in camera view 303, (ii) bounding box 362 corresponds to person 344 in camera view 303, and (iii) bounding box 364 corresponds to person 342 in camera view 303. Each of the bounding boxes in camera view 303 has a ground point that corresponds to a point on the ground plane 305 of the environment where a ray projected from camera 304 intersects a midpoint along the bottom of the bounding box. For example, bounding box 360 has ground point 361 on ground plane 305 where ray 345 projected from camera 304 intersects a midpoint along the bottom of bounding box 360. Similarly, bounding box 362 has ground point 363 on ground plane 305 where ray 343 projected from camera 304 intersects a midpoint along the bottom of bounding box 362, and bounding box 364 has ground point 365 on ground plane 305 where ray 341 projected from camera 304 intersects a midpoint along the bottom of bounding box 364.

In some embodiments where an individual camera view contains several groups of people, the ground points corresponding to the bounding boxes can be used to identify groups of persons for processing. In some instances, groups of persons located near each other within a single camera view are referred to herein as clusters of persons, or sometime simply as clusters. Identifying clusters of persons within a camera view, and then processing the clusters of persons separately from each other rather trying to process all of the persons at the same time can, in some instances, speed up the process of generating one or more sets of associated bounding boxes at least in part by dividing a large group of detected persons into several smaller clusters of detected persons, where each of the smaller clusters of detected persons can be processed in parallel.

For example, in some embodiments, generating the one or more sets of associated bounding boxes additionally includes, among other features, within each camera view of the plurality of camera views, identifying one or more clusters within the individual camera view. In operation, an individual cluster within the camera view includes two or more bounding boxes that have ground points within a threshold distance of each other on the ground plane. For example, in FIG. 3A, ground points 351, 353, and 355 corresponding to bounding boxes 350, 352, and 354, respectively, are in a cluster because the ground points 351, 353, and 355 in camera view 301 are within a threshold distance of each other on the ground plane 305. And ground points 361, 363, and 365 from camera view 303 are also in the cluster because ground points 361, 363, and 365 are within a threshold distance of each other on the ground plane 305.

In practice the threshold distance may be any threshold distance that is suitable for determining that the bounding boxes are sufficiently close to each other to warrant processing the bounding boxes as a cluster. For example, in a large environment, the threshold distance for grouping bounding boxes together may be several feet whereas in a smaller environment, the threshold distance for grouping bounding boxes together may be only a few feet or perhaps even less than one foot.

As mentioned earlier, each detected person in each camera view has a corresponding ground point on the ground plane 305. For example, camera view 301 includes ground points 351, 353, and 355 corresponding to three detected persons, and camera view 303 includes ground points 361, 363, and 365 corresponding to three detected persons. Each other camera view from each other camera will similarly include a ground points for each detected person in the camera view. In some embodiments, all the ground points from all of the camera views can be mapped to a graph within the two-dimensional ground plane 305. Some embodiments include performing a connected components analysis on the set of ground points on the graph via a Depth First Search (DFS) process. Some examples include using the results of the connected components analysis to identify clusters of persons within the graph. Some examples may additionally or alternatively include using the results of the connected components analysis to identify individual persons within the graph. Some examples may include performing a connected components analysis of the full set of ground points to identify clusters of ground points (i.e., to identify clusters), and then performing a connected components analysis on each cluster of ground points (i.e. on each cluster) to identify individual persons within each cluster.

For example, referring back to FIG. 1, camera view 116 and camera view 118 both depict group 140 containing persons 142, 144, and 146. In the context of the ground point based clusters described above with reference to FIG. 3A, group 140 corresponds to a cluster with three persons because the three persons in group 140 would have corresponding ground points fairly close to each other within the ground plane. Similarly, group 130 corresponds to a cluster with two persons because the two persons in group 130 would have corresponding ground points fairly close to each other within the ground plane. In some instances, group 120 may be referred to as a cluster with only a single person. However, in some embodiments, a single person may be processed without first grouping the single person into a cluster. Like camera views 116 and 118 in FIG. 1, camera views 301 and 303 in FIG. 3A may also include several clusters of persons. However, for ease of illustration, FIG. 3A only shows one cluster in the camera views 301 and 303.

After generating the clusters (and/or cluster groups in some embodiments) via the connected components analysis, the clusters (and/or cluster groups) can then be used to associate bounding boxes across multiple camera views. In some embodiments, associating bounding boxes with each other across multiple camera views is sometimes referred to herein as generating sets of associated bounding boxes.

To generate these sets of associated bounding boxes, some embodiments include, for each cluster (or cluster group), assigning each bounding box in each cluster (or cluster group) to one set of associated bounding boxes corresponding to a detected person based on the ground points of the bounding boxes. For example, in FIG. 3A, bounding box 350 in camera view 301 (associated with person 342, i.e., the batter) can be associated with bounding box 364 in camera view 303 (associated with person 342, i.e., the batter) because, within ground plane 305, ground point 351 corresponding to bounding box 350 is closer to ground point 365 corresponding to bounding box 364 than it is to the other ground points within the cluster shown in FIG. 3A. Similarly, bounding box 352 in camera view 301 (associated with person 344, i.e., the catcher) can be associated with bounding box 362 in camera view 303 (associated with person 344, i.e., the catcher) because, within ground plane 305, ground point 353 corresponding to bounding box 352 is closer to ground point 363 corresponding to bounding box 362 than it is to the other ground points within the cluster shown in FIG. 3A. And finally, bounding box 354 in camera view 301 (associated with person 346, i.e., the umpire) can be associated with bounding box 360 in camera view 303 (associated with person 346, i.e., the umpire) because, within ground plane 305, ground point 355 corresponding to bounding box 354 is closer to ground point 361 corresponding to bounding box 360 than it is to the other ground points shown in FIG. 3A.

In some embodiments, assigning each bounding box in the cluster (or cluster group) to one set of associated bounding boxes corresponding to a detected person based on the ground point of the bounding box includes, among other features, for a first pair of camera views comprising a first camera view obtained from a first camera and a second camera view obtained from a second camera, associating a first bounding box from the first camera view with a second bounding box from the second camera view by using a Hungarian algorithm approach based on Euclidean distances between ground points of the bounding boxes in the first camera view and ground points of the bounding boxes in the second camera view. Some embodiments may use bipartite matching procedures other than the Hungarian algorithm.

For example, with reference to FIG. 3A, for a first pair of camera views comprising a first camera view 301 obtained from a first camera 302 and a second camera view 303 obtained from a second camera 304, associating a first bounding box (e.g., bounding box 350) from the first camera view 301 with a second bounding box (e.g., bounding box 364) from the second camera view 303 by using a Hungarian algorithm approach based on Euclidean distances between ground points of the bounding boxes in the first camera view 301 (e.g., ground points 351, 353, and 355) and ground points of the bounding boxes in the second camera view (e.g., ground points 361, 363, and 365).

FIG. 3B shows aspects of generating a set of associated bounding boxes from different camera views according to some embodiments, including aspects of applying the Hungarian algorithm based on Euclidean distances within the ground plane between ground points corresponding to bounding boxes.

Table 307 in FIG. 3B shows a representation of the data used in connection with applying the Hungarian algorithm to the ground points of the cluster from the camera views obtained from cameras 302 and 304 depicted in more detail in FIG. 3A. The camera view from camera 302 includes ground points 351, 353, and 355 corresponding to bounding boxes 350, 352, and 354, respectively, and the camera view from camera 304 includes ground points 361, 363, and 365 corresponding to bounding boxes 360, 362, and 364, respectively.

The first row of data in table 307 includes, from left to right, (i) the Euclidean distance between ground point 351 (associated with bounding box 350 from camera 302) and ground point 361 (associated with bounding box 360 from camera 304), (ii) the Euclidean distance between ground point 351 (associated with bounding box 350 from camera 302) and ground point 363 (associated with bounding box 362 from camera 304), and (iii) the Euclidean distance between ground point 351 (associated with bounding box 350 from camera 302) and ground point 365 (associated with bounding box 364 from camera 304).

The second row of data in table 307 includes, from left to right, (i) the Euclidean distance between ground point 353 (associated with bounding box 352 from camera 302) and ground point 361 (associated with bounding box 360 from camera 304), (ii) the Euclidean distance between ground point 353 (associated with bounding box 352 from camera 302) and ground point 363 (associated with bounding box 362 from camera 304), and (iii) the Euclidean distance between ground point 353 (associated with bounding box 352 from camera 302) and ground point 365 (associated with bounding box 364 from camera 304).

And the third row of data in table 307 includes, from left to right, (i) the Euclidean distance between ground point 355 (associated with bounding box 354 from camera 302) and ground point 361 (associated with bounding box 360 from camera 304), (ii) the Euclidean distance between ground point 355 (associated with bounding box 354 from camera 302) and ground point 363 (associated with bounding box 362 from camera 304), and (iii) the Euclidean distance between ground point 355 (associated with bounding box 354 from camera 302) and ground point 365 (associated with bounding box 364 from camera 304).

Applying the Hungarian algorithm in a manner known to those of skill in the art to the data in table 307 matches bounding boxes from the two different camera views (from cameras 302 and 304) with each other based on the Euclidean distances between the ground points corresponding to the bounding boxes.

Applying the Hungarian algorithm to the ground points in sets of camera views is repeated for subsequent pairs of cameras positioned around the environment. For example, with reference to FIG. 1 again, the above-described approach is performed for (i) cameras 102 and 104, (ii) cameras 106 and 108, and (iii) cameras 110 and 112.

Accordingly, some embodiments additionally include, for a second pair of camera views comprising a third camera view obtained from a third camera and a fourth camera view obtained from a fourth camera, wherein the third camera view and the fourth camera view include ground points from the same cluster (or cluster group), associating a first bounding box from the third camera view with a second bounding box from the fourth camera view by using the Hungarian algorithm approach based on Euclidean distances between ground points of the bounding boxes in the cluster of ground points corresponding to the bounding boxes in the third and fourth camera views.

For example, with reference to FIG. 3B again, Table 313 shows a representation of the data used in connection with applying the Hungarian algorithm to the ground points from camera views obtained from a second set of cameras 306 and 308. The camera view from camera 306 includes ground points 371, 373, and 375 corresponding to bounding boxes 370, 372, and 374, respectively, and the camera view from camera 308 includes ground points 381, 383, and 385 corresponding to bounding boxes 380, 382, and 384, respectively.

The first row of data in table 313 includes, from left to right, (i) the Euclidean distance between ground point 371 (associated with bounding box 370 from camera 306) and ground point 381 (associated with bounding box 380 from camera 308), (ii) the Euclidean distance between ground point 371 (associated with bounding box 370 from camera 306) and ground point 383 (associated with bounding box 382 from camera 308), and (iii) the Euclidean distance between ground point 371 (associated with bounding box 370 from camera 306) and ground point 385 (associated with bounding box 384 from camera 308).

Similarly, the second row of data in table 313 includes, from left to right, (i) the Euclidean distance between ground point 373 (associated with bounding box 372 from camera 306) and ground point 381 (associated with bounding box 380 from camera 308), (ii) the Euclidean distance between ground point 373 (associated with bounding box 372 from camera 306) and ground point 383 (associated with bounding box 382 from camera 308), and (iii) the Euclidean distance between ground point 373 (associated with bounding box 372 from camera 306) and ground point 385 (associated with bounding box 384 from camera 308).

And finally, the third row of data in table 313 includes, from left to right, (i) the Euclidean distance between ground point 375 (associated with bounding box 374 from camera 306) and ground point 381 (associated with bounding box 380 from camera 308), (ii) the Euclidean distance between ground point 375 (associated with bounding box 374 from camera 306) and ground point 383 (associated with bounding box 382 from camera 308), and (iii) the Euclidean distance between ground point 375 (associated with bounding box 374 from camera 306) and ground point 385 (associated with bounding box 384 from camera 308).

Applying the Hungarian algorithm in a manner known to those of skill in the art to the data in table 313 matches bounding boxes from the two different camera views (from cameras 306 and 308) with each other based on the Euclidean distances between the ground points corresponding to the bounding boxes.

Once the bounding boxes associated with the same detected person across sets of camera views have been matched to each other according to the Hungarian algorithm, some disclosed embodiments additionally include generating a composite ground point for each set of matched ground points. Generating the composite ground points enables a second iteration of the Hungarian algorithm. In this regard, the Hungarian algorithm is applied in a hierarchical fashion, by (i) at a first stage, associating bounding boxes between a set of camera pairs based on Euclidean distances between ground points, and (ii) at a second stage, associating sets of composite bounding boxes (having composite ground points) based on Euclidean distances between the composite ground points. For implementations with many cameras, this same process may be applied at additional levels of the hierarchy.

For example, level one may include (i) matching bounding boxes and/or ground points from a first camera and a second camera, and generating a first composite set of bounding boxes and/or ground points, (ii) matching bounding boxes and/or ground points from a third camera and a fourth camera, and generating a second composite set of bounding boxes and/or ground points, (iii) matching bounding boxes and/or ground points from a fifth camera and a sixth camera, and generating a third composite set of bounding boxes and/or ground points, (iv) matching bounding boxes and/or ground points from a seventh camera and an eighth camera, and generating a fourth composite set of bounding boxes and/or ground points, (v) matching bounding boxes and/or ground points from a ninth camera and a tenth camera, and generating a fifth composite set of bounding boxes and/or ground points, and (iv) matching bounding boxes and/or ground points from an eleventh camera and a twelfth camera, and generating a sixth composite set of bounding boxes and/or ground points.

Level two then includes (i) matching bounding boxes and/or ground points from the first composite set and the second composite set, and generating a seventh composite set of bounding boxes and/or ground points (which is based on the bounding boxes and/or ground points from the first, second, third, and fourth cameras) (ii) matching bounding boxes and/or ground points from the third composite set and the fourth composite set, and generating an eighth composite set of bounding boxes and/or ground points (which is based on the bounding boxes and/or ground points from the fifth, sixth, seventh, and eighth cameras), and (iii) matching bounding boxes and/or ground points from the fifth composite set and the sixth composite set, and generating a ninth composite set of bounding boxes and/or ground points (which is based on the bounding boxes and/or ground points from the ninth, tenth, eleventh, and twelfth cameras).

Level three then includes matching bounding boxes and/or ground points from the seventh composite set and the eighth composite set, and generating a tenth composite set of bounding boxes and/or ground points (which is based on the bounding boxes and/or ground points from the first, second, third, fourth, fifth, sixth, seventh, and eighth cameras).

The final level then includes matching bounding boxes and/or ground points from the ninth composite set (which is based on the bounding boxes and/or ground points from the ninth, tenth, eleventh, and twelfth cameras) with bounding boxes and/or ground points from the tenth composite set (which is based on the bounding boxes and/or ground points from the first, second, third, fourth, fifth, sixth, seventh, and eighth cameras) to generate a final set of associated bounding boxes across all of the different camera views.

Aspects of this hierarchical approach are illustrated in FIGS. 3B and 3C.

For example, in FIG. 3B, each of the bounding boxes 350, 352, and 354 from camera 302 is associated with one of the bounding boxes 360, 362, and 364 from camera 304. Here, based on the Euclidean distances between the ground points associated with the bounding boxes, bounding box 350 (from camera 302) is associated with bounding box 364 (from camera 304), bounding box 352 (from camera 302) is associated with bounding box 362 (from camera 304), and bounding box 354 (from camera 302) is associated with bounding box 360 (from camera 304). Composite view 309 is then generated based on the above-described bounding box associations between cameras 302 and 304. In particular, composite view 309 includes (i) composite ground point 368, which is the average of ground points 355 and 361 (corresponding to the first composite bounding box in composite view 309), (ii) composite ground point 367 which is the average of ground points 353 and 363 (corresponding to the second composite bounding box in composite view 309), and (iii) composite ground point 366, which is the average of ground points 351 and 365 (corresponding to the third composite bounding box in composite view 309).

Similarly, each of the bounding boxes 370, 372, and 374 from camera 306 is associated with one of the bounding boxes 380, 382, and 384 from camera 308. Here, based on the Euclidean distances between the ground points associated with the bounding boxes, bounding box 370 (from camera 306) is associated with bounding box 380 (from camera 308), bounding box 372 (from camera 306) is associated with bounding box 382 (from camera 308), and bounding box 374 (from camera 306) is associated with bounding box 384 (from camera 308). Composite view 315 is then generated based on the above-described bounding box associations between cameras 306 and 308. In particular, composite view 315 includes (i) composite ground point 378, which is the average of ground points 375 and 385 (corresponding to the first composite bounding box in composite view 315), (ii) composite ground point 377 which is the average of ground points 373 and 383 (corresponding to the second composite bounding box in composite view 315), and (iii) composite ground point 376, which is the average of ground points 371 and 381 (corresponding to the third composite bounding box in composite view 315).

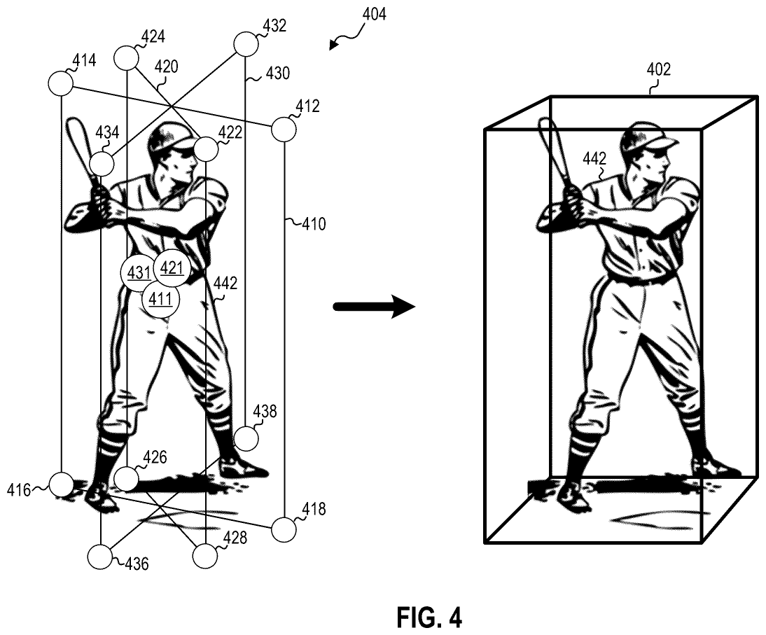

FIG. 3C shows aspects of generating a set of associated bounding boxes and/or ground points from different camera views according to some embodiments, including associating composite bounding boxes and/or ground points from two composite camera views. In particular, FIG. 3C shows aspects of generating a second level composite view 319 from first level composite views 309 and 315. First, the Hungarian algorithm is applied to match the first level composite bounding boxes and/or ground points from the first level composite views 309 and 315. Then, a second level composite view 319 is generated for use in either (i) a third level of processing or (ii) generating a bounding cuboid (FIG. 4).

Table 317 shows the data used in connection with applying the Hungarian algorithm to the composite ground points from composite views 309 and 315. Composite view 309 (based on cameras 302 and 304 in FIG. 3B) includes ground points 366, 367, and 368, and composite view 315 (based on cameras 306 and 308 in FIG. 3B) includes ground points 376, 377, and 378.

The first row of data in table 317 includes, from left to right, (i) the Euclidean distance between composite ground point 368 (from composite view 309) and composite ground point 378 (from composite view 315), (ii) the Euclidean distance between composite ground point 368 (from composite view 309) and composite ground point 377 (from composite view 315), and (iii) the Euclidean distance between composite ground point 368 (from composite view 309) and composite ground point 376 (from composite view 315).

The second row of data in table 317 includes, from left to right, (i) the Euclidean distance between composite ground point 367 (from composite view 309) and composite ground point 378 (from composite view 315), (ii) the Euclidean distance between composite ground point 367 (from composite view 309) and composite ground point 377 (from composite view 315), and (iii) the Euclidean distance between composite ground point 367 (from composite view 309) and composite ground point 376 (from composite view 315).

And the third row of data in table 317 includes, from left to right, (i) the Euclidean distance between composite ground point 366 (from composite view 309) and composite ground point 378 (from composite view 315), (ii) the Euclidean distance between composite ground point 366 (from composite view 309) and composite ground point 377 (from composite view 315), and (iii) the Euclidean distance between composite ground point 366 (from composite view 309) and composite ground point 376 (from composite view 315).

After matching composite bounding boxes from composite camera views with each other according to the Hungarian algorithm, some embodiments additionally include generating a second level composite ground point for each set of matched first level composite ground points. For example, second level composite view 319 includes (i) second level composite ground point 396, which is the average of first level composite ground point 368 (from first level composite view 309) and first level composite ground point 378 (from first level composite view 315), (ii) second level composite ground point 394 which is the average of first level ground point 367 (from first level composite view 309) and first level composite ground point 377 (from first level composite view 315), and (iii) second level composite ground point 392, which is the average of first level ground point 366 (from first level composite view 309) and first level ground point 376 (from first level composite view 315).

These second level composite ground points and their corresponding second level composite bounding boxes can then be used for either (i) a third level of processing or (ii) generating a bounding cuboid in the manner described with reference to FIG. 4. For example, when used for a third level of processing, the second level composite ground points from second level composite view 319 can be combined with another set of second level composite ground points from a different second level composite view (obtained from different first level composite views) to generate a third level composite view with its own set of third level composite ground points. And when used for generating a bounding cuboid, the bounding boxes matched with each other across all of the camera views can be used to generate a single bounding cuboid corresponding to a single detected person.

### Iv. Generating Bounding Cuboids Based on Sets of Associated Bounding Boxes

FIG. 4 shows aspects of generating a bounding cuboid 402 for a set of associated bounding boxes 404 according to some embodiments.

For example, some embodiments include, among of other features, for each timeframe of a plurality of timeframes of video data obtained from the plurality of cameras, generating a bounding cuboid for each set of associated bounding boxes for the timeframe.

In some embodiments, for each timeframe of the plurality of timeframes, generating a bounding cuboid for each set of associated bounding boxes for the timeframe includes, among other features: (i) for every bounding box in the set of associated bounding boxes, generating a point at each corner of the bounding box; and (ii) generating a bounding cuboid corresponding to the set of associated bounding boxes that encloses substantially all of the points at each corner of all of the bounding boxes within the set of associated bounding boxes.

The set of associated bounding boxes 404 from the camera views during the timeframe depicted in FIG. 4 includes bounding box 410, bounding box 420, and bounding box 430. The example depicted in FIG. 4 shows only three bounding boxes for ease of illustration.

In operation, the set of associated bounding boxes corresponding to an individual detected person includes two or more bounding boxes. In some embodiments, the set of associated bounding boxes may include more than three bounding boxes. Further, the set of associated bounding boxes 404 from the camera views can be obtained in any suitable manner, including but not limited to the manner described with reference to FIGS. 3A, 3B, and 3C.

In some embodiments, the set of associated bounding boxes corresponding to an individual detected person may include a bounding box from each of the camera views obtained from each of the cameras. In some embodiments, the set of associated bounding boxes corresponding to an individual detected person may include a bounding box from some (but not all) of the camera views obtained from each of the cameras, which may be the case in scenarios where the detected person may not have been visible in every camera view. In some embodiments, the set of associated bounding boxes may include one or both of (i) bounding boxes from individual camera views and/or (ii) composite bounding boxes generated by combining bounding boxes from multiple camera views. However, in some embodiments, composite bounding boxes may not be used. Rather than using composite bounding boxes for generating a bounding cuboid, the composite ground points associated with composite bounding boxes may instead just be used to facilitate the matching of sets of associated bounding boxes across pairs of camera views.

Nevertheless, regardless of how many associated bounding boxes might be used, disclosed embodiments include generating a point at each corner of the bounding box. For example, (i) bounding box 410 includes points 412, 414, 416, and 418, (ii) bounding box 420 includes points 422, 424, 426, and 428, and (iii) bounding box 430 includes points 432, 434, 436, and 438. Although each bounding box in the set of associated bounding boxes 404 corresponds to the same detected person, the bounding boxes 410, 420, and 430 in the set of associated bounding boxes 404 may each have different sizes and different orientations because each of the bounding boxes was obtained from a different camera view (and/or perhaps a different composite camera view in embodiments that might use composite bounding boxes in connection with generating bounding cuboids).

After generating a point at each corner of each bounding box in the set of associated bounding boxes, some embodiments include generating a bounding cuboid corresponding to the set of associated bounding boxes that encloses all or substantially all of the points at each corner of all of the bounding boxes within the set of associated bounding boxes.

For example, bounding cuboid 402 is a cuboid that encloses substantially of the points at the corners of all of the bounding boxes 410, 420, and 430 within the set of associated bounding boxes 404.

The process of generating the bounding cuboid 402 based on the corners of all of the bounding boxes 410, 420, and 430 within the set of associated bounding boxes 404 for detected person 442 is performed in the same way (or substantially the same way) for each other set of associated bounding boxes corresponding to each other detected person in the camera views. For example, with reference to FIG. 3A, embodiments include generating a bounding cuboid for person 342, a bounding cuboid for person 344, and a bounding cuboid for person 346.

In some embodiments, generating the bounding cuboid 402 corresponding to the set of associated bounding boxes 410, 420, and 430 that encloses substantially all of the points at each corner of all of the bounding boxes within the set of associated bounding boxes comprises:
(i) estimating a centroid for the set of associated bounding boxes by triangulating mid-points from all of the bounding boxes within the set of associated bounding boxes 410, 420, and 430;
(ii) back-projecting all four corners of each bounding box within the set of associated bounding boxes onto a plane perpendicular to a camera view intersecting at the estimated centroid; and (iii) generating the bounding cuboid 402 based on the back-projected corners and the estimated centroids.

For example, in the scenario depicted in FIG. 4, some embodiments first include estimating a centroid for each of the bounding boxes 410, 420, and 430, including (i) estimating a centroid 411 for bounding box 410, (ii) estimating centroid 421 for bounding box 420, and (iii) estimating a centroid 431 for bounding box 430.

Then, for each bounding box in the set of associated bounding boxes 410, 420, and 430, some embodiments include back-projecting all four corners of each bounding box within the set of associated bounding boxes onto a plane perpendicular to a camera view intersecting at the estimated centroid, including (i) for bounding box 410, back-projecting points 412, 414, 416, and 418 at the corners of bounding box 410 onto a plane perpendicular to a camera view interesting at centroid 411, (ii) for bounding box 420, back-projecting points 422, 424, 426, and 428 at the corners of bounding box 420 onto a plane perpendicular to a camera view interesting at centroid 421, and (iii) for bounding box 430, back-projecting points 432, 434, 436, and 438 at the corners of bounding box 430 onto a plane perpendicular to a camera view interesting at centroid 431.

Then, some embodiments additionally include generating the bounding cuboid 402 based on (i) the back-projected corners at each of the bounding boxes 410, 420, and 430 and (ii) the estimated centroids 411, 421, and 431.

### V. Associating Bounding Cuboids with Tracklets

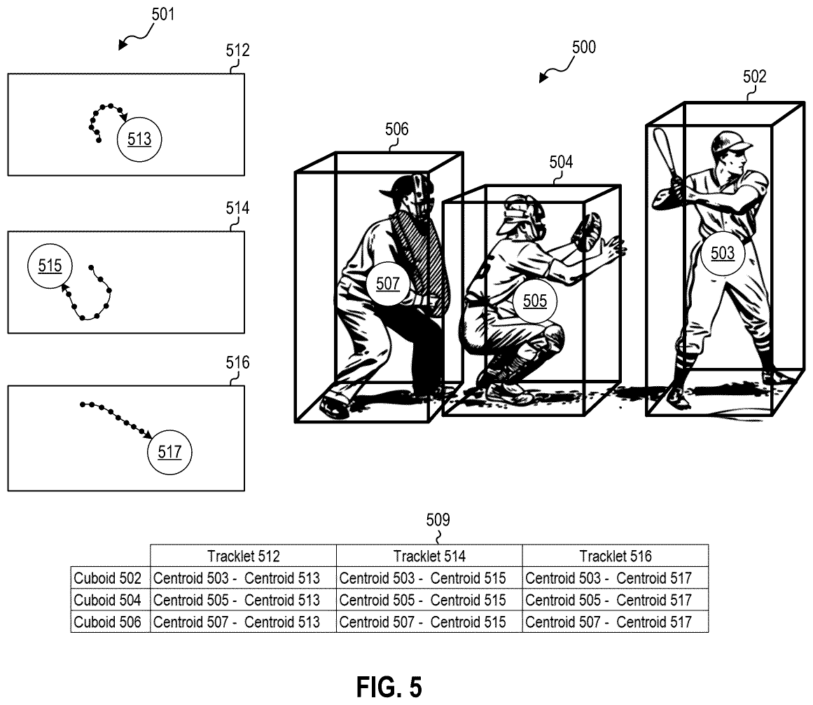

FIG. 5 shows aspects of associating generated bounding cuboids with tracklets corresponding to persons according to some embodiments.

After generating a bounding cuboid for each detected person, disclosed embodiments next include, among other features, for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, where each tracklet corresponds to a set of historical positions of one of the persons detected in the plurality of camera views.

For example, FIG. 5 shows a set of generated cuboids 500. The set of generated cuboids 500 includes cuboid 502, cuboid 504, and cuboid 506. Each generated cuboid in the set of generated cuboids 500 has a corresponding centroid in space. For example, cuboid 502 has corresponding centroid 503, cuboid 504 has corresponding centroid 505, and cuboid 506 has corresponding centroid 507.

FIG. 5 also depicts aspects of a set of tracklets 501. The set of tracklets 501 includes tracklet 512, tracklet 514, and tracklet 516. Each tracklet corresponds to a set of historical positions of one of the persons being tracked within the environment. For example, the dotted line in each tracklet represents a set of historical positions of the detected person corresponding to the tracklet.

Each of the tracklets in some embodiments also includes an estimated future position of a tracked person (i.e., an estimated future position of a centroid of the tracked person) based on the set of historical positions in the tracklet. For example, (i) estimated future position (i.e., centroid 513) associated with tracklet 512 is based on the set of historical positions of the tracked person corresponding to tracklet 512, (ii) estimated future position (i.e., centroid 515) associated with tracklet 514 is based on the set of historical positions of the tracked person corresponding to tracklet 514, and (iii) estimated future position (i.e., centroid 517) associated with tracklet 516 is based on the set of historical positions of the tracked person corresponding to tracklet 516.

The tracklets depicted in FIG. 5 show the historical positions and the estimated future positions as individual points. However, in some embodiments, each historical position and each estimated future position corresponds to a cuboid. For example, each of the historical positions for a tracklet corresponds to a historical cuboid generated during a prior timeframe, where each historical cuboid has a corresponding centroid. And each of the estimated future positions corresponds to an estimated cuboid for a current timeframe, where each estimated cuboid has a corresponding centroid.

To create each estimated cuboid for each tracklet (i.e., tracklets 512, 514, and 516) in the set of tracklets 501, some embodiments include, for each tracklet in the plurality of tracklets, using a Kalman filter to generate the estimated (or predicted) future positions for each of the plurality of tracklets for the timeframe. In some embodiments, the Kalman filter used to generate the estimated future positions is configured to, for each tracklet, (i) assume acceleration of the tracked person within the plurality of timeframes is constant or alternatively, (ii) treat a time derivative of acceleration and a third moment of position in each timeframe of the plurality of timeframes as noise.

In some embodiments, the Kalman filter comprises a third degree Kalman filter with eighteen dimensional states, where the eighteen dimensional states comprise (i) six coordinates that define a bounding cuboid corresponding to a person, (ii) six coordinates that define velocity of the bounding cuboid corresponding to the person, and (iii) six coordinates that define acceleration of the bounding cuboid corresponding to the person.

Nevertheless, regardless of the filter configuration and/or the particular procedures for estimating future positions based past positions, once the future positions have been estimated, some embodiments include, for each generated bounding cuboid (i.e., each of cuboids 502, 504, and 506), associating the generated bounding cuboid with one of the plurality of tracklets 501 for the timeframe based on (a) a position of the generated bounding cuboid during the timeframe and (b) predicted future positions for each of the plurality of tracklets for the timeframe.

In some embodiments, for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe includes, among other features, creating one or more cuboid groups. In operation, an individual cuboid group contains two or more generated bounding cuboids that have centroids within a threshold distance of each other.

Similar to the threshold distance(s) used for determining whether to put individual bounding boxes into a cluster and/or the threshold distance(s) for determining whether to group clusters into a cluster group, the threshold distance(s) for determining whether to put bounding cuboids into a cuboid group may be any threshold distance that is suitable for determining that the centroids of the bounding cuboids are sufficiently close to each other to warrant inclusion within the same cuboid group.

For example, some embodiments include mapping the centroids of the bounding cuboids to a three-dimensional space, and then performing a connected components analysis on the centroids via a Depth First Search (DFS) process. Some examples include using the results of the connected components analysis to identify groups of bounding cuboids. Some examples may additionally or alternatively include using the results of the connected components analysis to identify individual persons or individual cuboids corresponding to individual persons. Some examples may include performing a connected components analysis of the centroids to identify clusters of cuboids (i.e., to identify cuboid groups), and then performing a connected components analysis on each cuboid group to identify individual persons within each cuboid group or individual cuboids corresponding to individual persons.

Grouping cuboids into cuboid groups, and then processing each cuboid group separately from each other rather trying to process all of the cuboids at the same time can, in some instances, speed up the process of associating cuboids with tracklets by dividing a large group of generated cuboids into several cuboid groups, where each cuboid group can be processed in parallel. Although FIG. 5 shows a single cuboid group, in practice, a typical implementation may include several cuboid groups containing cuboids corresponding to many detected persons.

For example, in embodiments where the environment includes a baseball field as depicted in the example shown in FIG. 1, there may be between perhaps ten to fifteen persons on the baseball field in different locations. Such embodiments may include a cuboid group near home plate (e.g., a batter, catcher, and home plate umpire as shown in FIG. 5), a cuboid group near first base (e.g., a first baseman, a base runner, a first base coach, and a first base umpire), a cuboid group near second base (e.g., a second baseman, a base runner, and a second base umpire), and so on. Similarly, as players move during game play, it may be advantageous to create cuboid groups at different times, such as creating a cuboid group as a right fielder and centerfielder both run toward a fly ball. Further, cuboid groups may change over time during game play, such as when a base runner runs from first base (leaving a cuboid group near first base) to second base (joining a cuboid group near second base).

After grouping the cuboids at the time frame into a cuboid group, some embodiments include, within each cuboid group, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets. Some embodiments may include performing a connected components analysis on the centroids via a DFS process, for example, to disambiguate centroids corresponding to different detected persons from each other.

In some embodiments, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets includes, among other features, associating each generated bounding cuboid within the cuboid group with a tracklet in the plurality of tracklets by using a Hungarian algorithm approach based on Euclidean distances between centroids of the bounding cuboids in cuboid group and predicted centroids for each tracklet in the plurality of tracklets. Some embodiments may use bipartite matching procedures other than the Hungarian algorithm.

Table 509 in FIG. 5 shows a representation of the data used in connection with applying the Hungarian algorithm to the centroids (i.e., centroids 503, 505, and 507) of the cuboids (i.e., cuboids 502, 504, and 506) of the cuboid group 500 and the predicted centroids (i.e., predicted centroids 513, 515, and 517) of the tracklets (i.e., tracklets 512, 514, and 516) of the plurality of tracklets 501. Applying the Hungarian algorithm in a manner known to those of skill in the art to the data in table 509 matches individual cuboids within the cuboid group 500 with individual tracklets of the plurality of tracklets 501.

The first row of data in table 509 includes, from left to right, (i) the Euclidean distance between centroid 503 (of cuboid 502) and predicted centroid 513 (associated with tracklet 512), (ii) the Euclidean distance between centroid 503 (of cuboid 502) and centroid 515 (associated with tracklet 514), and (iii) the Euclidean distance between centroid 503 (of cuboid 502) and predicted centroid 517 (associated with tracklet 516).

Similarly, the second row of data in table 509 includes, from left to right, (i) the Euclidean distance between centroid 505 (of cuboid 504) and predicted centroid 513 (associated with tracklet 512), (ii) the Euclidean distance between centroid 505 (of cuboid 504) and centroid 515 (associated with tracklet 514), and (iii) the Euclidean distance between centroid 505 (of cuboid 504) and predicted centroid 517 (associated with tracklet 516).

And the third row of data in table 509 includes, from left to right, (i) the Euclidean distance between centroid 507 (of cuboid 506) and predicted centroid 513 (associated with tracklet 512), (ii) the Euclidean distance between centroid 507 (of cuboid 506) and centroid 515 (associated with tracklet 514), and (iii) the Euclidean distance between centroid 507 (of cuboid 506) and predicted centroid 517 (associated with tracklet 516).

In the example shown in FIG. 5, the result of applying the Hungarian algorithm to the data in the table 509 is that cuboid 502 is matched with tracklet 516 (corresponding to the batter), cuboid 504 is matched with tracklet 512 (corresponding to the catcher), and cuboid 506 is matched with tracklet 514 (corresponding to the umpire). Cuboid 502 is matched with tracklet 516 because the centroid 503 of cuboid 502 is closest (in Euclidean space) to predicted centroid 517 corresponding to tracklet 516. Similarly, cuboid 504 is matched with tracklet 512 because the centroid 505 of cuboid 504 is closest (in Euclidean space) to predicted centroid 513 corresponding to tracklet 512. And cuboid 506 is matched with tracklet 514 because the centroid 507 of cuboid 506 is closest (in Euclidean space) to predicted centroid 515 corresponding to tracklet 514.

### VI. Associating Cuboids with Tracked Persons

After matching each of the centroids of the cuboids to a tracklet, in some embodiments the system is additionally able to associate a particular cuboid (associated with a detected person) with a particular tracked person. Some embodiments where the persons include players may additionally include, for each player, identifying a role of the player by mapping an initial position of the player within the sports environment to a particular region within the sports environment.

For example, some embodiments include associating each tracklet to a particular region of the field based at least in part on the position data associated with each tracklet. For example, tracklets with position data (e.g., the initial position of the tracklet, or perhaps several recent positions of the tracklet) near home plate may be associated with a batter, catcher, or home plate umpire. Similarly, a tracklet with position data near the pitching mound may be associated with a pitcher. A tracklet with position data near second base may be associated with a second base umpire. A tracklet with position data near first base may be associated with a first baseman, a base runner, a first base coach, or a first base umpire. A tracklet with position data near center field can be associated with a center fielder, a tracklet with position data near right field can be associated with a right fielder, and a tracklet with position data near left field can be associated with a left fielder.

In some embodiments, additional data can be used to improve a confidence level associated with a mapping between a cuboid and a tracklet. In the context of a baseball field environment, the additional data that can be used to improve the confidence level of a cuboid-to-tracklet mapping includes, but is not limited to, a jersey color, the presence (or absence) of a batting helmet, the presence (or absence) of a baseball glove. In context of other sporting or athletic environments, the additional data that can be used to improve the confidence level of a cuboid-to-tracklet mapping may include any other data that may be extracted from one or more frames of video data that can be helpful in distinguishing between players. In the context of other environments, the additional data may include the color or style of clothing worn by the persons. For example, an employee may wear a uniform and a customer may not wear the uniform). A welder in a manufacturing facility may wear welding gloves and a welder's helmet whereas a lift operator may wear a hard hat and goggles.

For example, in a baseball game situation where two teams are wearing different colored jerseys, the jersey color can be used to distinguish between a base runner and an infielder. For instance, when matching a cuboid with a tracklet, if the jersey color of the detected person associated with the cuboid is consistent with the jersey color of the tracked person associated with the tracklet, then the confidence of the cuboid-to-tracklet mapping may be high. When the confidence of the cuboid-to-tracklet mapping is high, then the cuboid may be added to the tracklet as part of the tracklet history. In contrast, if the jersey color of the detected person associated with the cuboid is different than the jersey color of the tracked person associated with the tracklet, then the confidence of the cuboid-to-tracklet mapping may be low. When the confidence of the cuboid-to-tracklet mapping is low, then that cuboid may not be added to the tracklet as part of the tracklet history. But since the cuboid-to-tracklet mapping happens often, perhaps even up to a few times per second, excluding some potential cuboid-to-tracklet mismatches from the historical position data associated with the tracklet should not materially affect the sufficiency of the historical position data for use in future position prediction.

Some embodiments may additionally include, for at least one player, correlating the player with the data associated with the player, where the data associated with the player includes game statistics associated with the player. For example, in the baseball context, if pitch-by-pitch data is available for a particular game (e.g., via game_PK, a Grand Unified Master Baseball Object (GUMBO) feed, an Application Programming Interface (API) configured to facilitate retrieval or receipt of game data), then player positions can be mapped to player identifiers (e.g., players IDs) from the game data on a play-by-play basis. In some instances, the game data can additionally or alternatively be used in connection with assessing the confidence level of a cuboid-to-tracklet mapping.

### Vii. Tracking Additional Objects within an Environment

In addition to tracking persons within an environment, some embodiments may additional include tracking other objects within an environment. For example, in embodiments where the environment is a sporting or athletic environment, some embodiments may additionally include tracking one or more balls within the environment.

In some embodiments, tracking one or more balls within an environment includes generating a point cloud comprising points where two rays projected from each of two of the plurality of cameras (e.g., cameras 102, 104, 106, 108, 110, and 112 in FIG. 1) intersect an object detected by both cameras in the pair of two cameras. For example, for an object (e.g., a ball) detected within the environment 100 depicted in FIG. 1, the point cloud associated with the detected object would include many different points detected by the plurality of cameras positioned around the environment.

Thus, in a scenario where multiple cameras in the plurality of cameras detect the object, the point cloud includes a plurality of points, where each point in the point cloud corresponds to a point in space where two rays projected from two cameras in the plurality of cameras intersect the object detected by both of the two cameras.

Some embodiments include selecting a subset of points in the point cloud. The selected subset of points in the point cloud includes points that are within a threshold distance of a threshold number of other points in the point cloud.

For example, a point in the point cloud that is not close to other points in the point cloud would not be part of the selected subset of points because that point is unlikely to correspond to a location where two rays from two cameras intersected the same detected object associated with the other points in the point cloud. Similarly, if two or three points are close to each other but are not close to most of the other points in the point cloud, then those two or three points would also not be part of the selected subset of points because, like the case with the single point, a few points that are not close to most of the other points in the point are also unlikely to correspond to points where two rays from two cameras intersected the same object corresponding to the other points in the point cloud.

Some embodiments include performing a connected components analysis on points in the point cloud to identify subsets of points that correspond to objects. For example, some embodiments include mapping all of the points in the point cloud to a graph within a three-dimensional space, and then performing a connected components analysis to the points in the point cloud via a Depth First Search (DFS) procedure. Some examples include using the results of the connected components analysis to identify clusters of points within the graph. Some examples may additionally or alternatively include using the results of the connected components analysis to identify individual objects. Some examples may include performing a connected components analysis of the points in the point cloud to identify clusters of points, and then performing a connected components analysis on each cluster of points to identify individual objects. In some such embodiments, one or more subsets of points are selected from a cluster identified via the connected components analysis, where each subset of points corresponds to a detected object. In operation, the selected subset of points for a detected object includes points that are within a threshold distance of a threshold number of other points.

Next, some embodiments include generating a centroid based on the selected subset of points. In operation, the generated centroid corresponds roughly to the center of all of the points in the selected subset of points.

Next, some embodiments include generating a cuboid based on the generated centroid. In situations where the object to be tracked is a ball, the dimensions of the ball are generally known. For example, all baseballs are generally the same size. Similarly, if the object to be tracked is a basketball, then all basketballs are generally the same size. The same is true for soccer balls, tennis balls, and other types of balls that may be tracked by the disclosed systems and methods. Because the dimensions of the ball are known, the size of the cuboid that should be associated with the ball is also known. Thus, the cuboid for a detected object can be generated without necessarily implementing the cuboid generation procedures shown and described with reference to FIG. 4.

Embodiments where a single ball is tracked within the environment will have a single object tracklet corresponding to that single ball. In such embodiments, the position of the centroid associated with the cuboid enclosing the ball can be added to the tracklet corresponding to the ball without necessarily implementing the cuboid-to-tracklet mapping procedures shown and described with reference to FIG. 5.

However, in some situations, it may be desirable to track more than one ball within an environment. For example, if the environment is a basketball court during a basketball practice session where several balls may be on the court at any given time, it may be desirable to track each ball separately.

Accordingly, some embodiments include generating a cuboid for each detected ball within the environment in the manner described above by, for example, generating a cuboid for each detected ball based on a centroid of points in a selected subset of points from a point cloud corresponding to the detected ball. Because each separate ball detected by a camera pair will generate a point, the point cloud will include sub-clouds with high point densities, where each sub-cloud with a high point density corresponds to a detected ball.

Next, some disclosed embodiments include assigning (or matching) each cuboid (corresponding to a detected ball) with one object tracklet of a plurality of object tracklets (where the plurality of object tracklets includes an object tracklet for each object (e.g., a ball) tracked within the environment) based on distances between (i) positions of centroids of the cuboids corresponding to the detected objects (e.g., balls), and (ii) positions of predicted centroids for each object tracklet in the plurality of object tracklets. In some instances, associating each generated cuboid (corresponding to a detected object) with an object tracklet (associated with a tracked object) includes using a Hungarian algorithm approach based on Euclidean distances between centroids of cuboids of detected objects and predicted centroids for each object tracklet in the plurality of object tracklets. Some embodiments may use bipartite matching procedures other than the Hungarian algorithm.

In operation, the process of using the Hungarian algorithm to associate cuboids corresponding to detected objects (e.g., balls) with object tracklets associated with tracked objects (e.g., tracked balls) is the same (or substantially the same) as using the Hungarian algorithm to associate generated cuboids associated with detected persons with tracklets associated with tracked persons shown and described with reference to FIG. 5.

### VIII. Example Methods

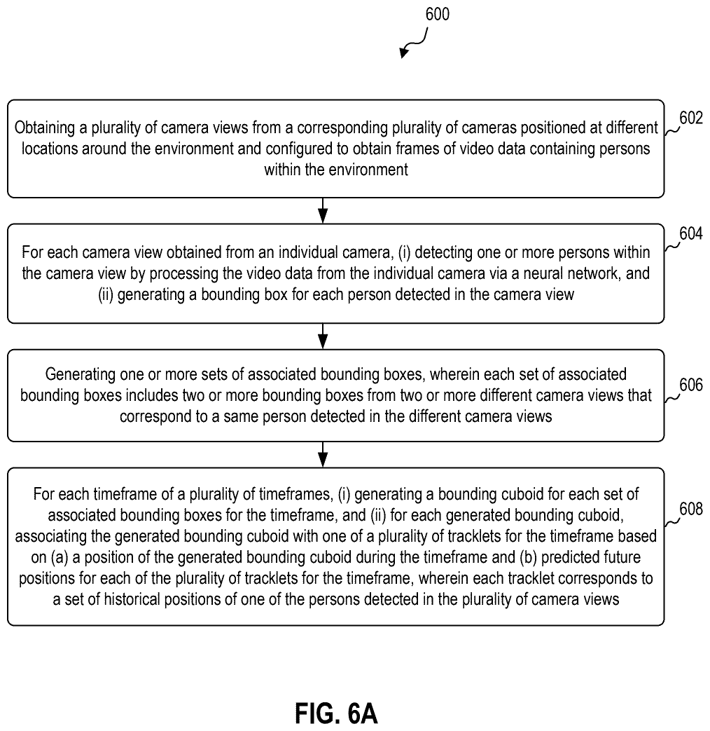

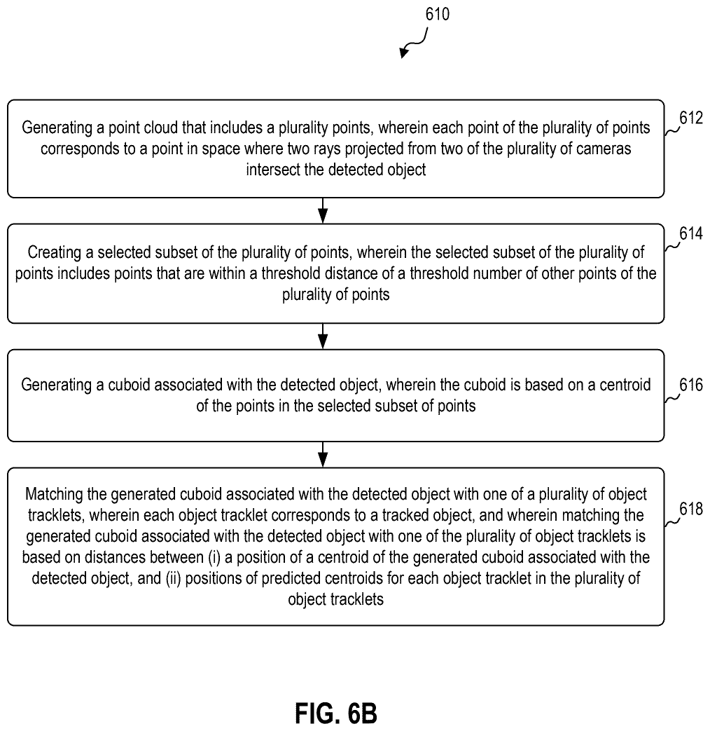

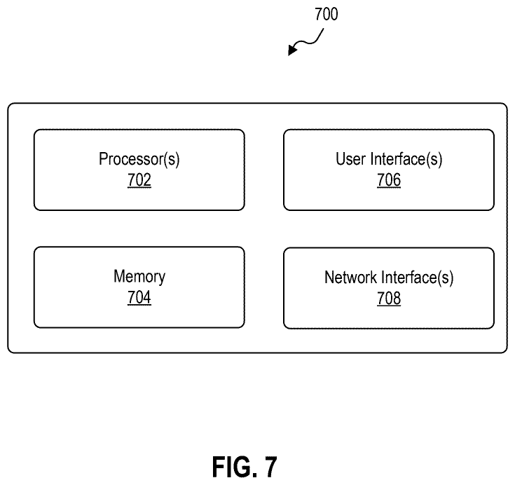

FIGS. 6A and 6B show aspects of example methods for tracking persons (method 600) and tracking objects (method 610) within an environment. Some embodiments may implement both method 600 and method 610 at the same (or substantially the same time). Some embodiments may implement method 600 separately from method 610. Some embodiments may implement method 600 without method 610, and other embodiments may implement method 610 without method 600. In operation, method 600 and/or method 610 are implemented via a computing system, including but not limited to the computing system 700 shown and described with reference to FIG. 7 or any other suitable computing system in any configuration now known or later developed that is suitable for performing the functions disclosed herein.

For example, in some embodiments, all of the method steps may be performed by the same computing system. In other embodiments, some of the method steps may be performed by a first computing system at a first location (e.g., a local computing system), and some of the method steps may be performed by a second computing system at a second location (e.g., a remote computing system), where the first and second computing systems are configured to communicate with each other via any suitable network infrastructure.

FIG. 6A shows aspects of an example method 600 for tracking persons in an environment according to some embodiments.

Method 600 begins at block 602, which includes obtaining a plurality of camera views from a corresponding plurality of cameras positioned at different locations around the environment and configured to obtain frames of video data containing persons within the environment.

Next, method 600 advances to block 604, which includes, for each camera view obtained from an individual camera, (i) detecting one or more persons within the camera view by processing the video data from the individual camera via a neural network, and (ii) generating a bounding box for each person detected in the camera view. In some embodiments, the neural network comprises an anchor-free, single-stage object detector. In some embodiments, the neural network has been trained to identify persons. In some embodiments, the neural network has been trained to identify objects. In some embodiments, the neural network has been trained to identify both persons and objects.

In some embodiments, the step of detecting one or more persons within the camera view by processing the video data from the individual camera via a neural network at method block 604 includes: (i) for frames of video data obtained from an individual camera, generating input tensor data based on an anchor frame selected from the frames of video data obtained from the individual camera; (ii) detecting the one or more persons via the neural network based on the input tensor data; and (iii) generating output tensor data corresponding to each person detected within the anchor frame.

In some embodiments, the step of generating a bounding box for each person detected in the camera view at method block 604 includes, for each person detected within the anchor frame, generating the bounding box corresponding to the person detected within the anchor frame based on the output tensor data corresponding to the person detected within the anchor frame.

In some embodiments, the step of generating a bounding box for each person detected in the camera view at method block 604 includes, when the camera view includes a set of bounding boxes comprising two or more bounding boxes surrounding at least a portion of the individual person(s), (i) using a non-maximum suppression filtering procedure based on an intersection over minimum area (IoMA) metric to rank each bounding box, and (ii) selecting one of the bounding boxes for further processing based on the bounding box rankings.

In some embodiments, the step of generating a bounding box for each person detected in the camera view at method block 604 includes: (A) when an individual camera view includes an object between the individual camera and the individual person(s) that at least partially obstructs the individual camera's view of the individual person(s), and the individual camera view includes a set of bounding boxes comprising two or more bounding boxes surrounding at least a portion of each of the individual person(s), (i) using a non-maximum suppression filtering procedure based on an intersection over minimum area (IoMA) metric to rank each bounding box, and (ii) selecting one or more of the bounding boxes for further processing based on the bounding box rankings; and (B) when the individual camera view does not contain an object between the individual camera and the individual person(s) that at least partially obstructs the individual camera's view of the individual person(s), and the individual camera view includes a set of bounding boxes comprising two or more bounding boxes surrounding at least a portion of each of the individual person(s), (i) using a non-maximum suppression filtering procedure based on an intersection over union (IoU) metric to rank each bounding box, and (ii) selecting one or more of the bounding boxes for further processing based on the bounding box rankings.

Next, method 600 advances to block 606, which includes generating one or more sets of associated bounding boxes, wherein each set of associated bounding boxes includes two or more bounding boxes from two or more different camera views that correspond to a same person detected in the different camera views.

In some embodiments, generating one or more sets of associated bounding boxes at block 606 includes, for each bounding box in each camera view, generating a ground point for the bounding box that corresponds to a point on a ground plane of the environment where a ray projected from the camera that obtained the camera view intersects a midpoint along a bottom of the bounding box.

In some embodiments, generating one or more sets of associated bounding boxes at block 606 additionally includes: (i) mapping ground points corresponding to bounding boxes in each of the camera views to a graph within the ground pane; (ii) performing a connected components analysis on the ground points to identify clusters of ground points, wherein an individual cluster includes ground points within a threshold distance of each other in the ground plane; and (iii) within each cluster, assigning each bounding box in the cluster to one set of associated bounding boxes corresponding to a detected person based on the ground point of the bounding box.

The step of, within each cluster, assigning each bounding box in the cluster to one set of associated bounding boxes corresponding to a detected person based on the ground point of the bounding box at block 606 in some embodiments comprises for a first pair of camera views comprising a first camera view obtained from a first camera and a second camera view obtained from a second camera, wherein the first camera view and the second camera view include ground points within a cluster, associating a first bounding box from the cluster in the first camera view with a second bounding box from the cluster in the second camera view by using a Hungarian algorithm approach based on Euclidean distances between ground points of the bounding boxes in the first camera view and ground points of the bounding boxes in the second camera view.

The step of, within each cluster, assigning each bounding box in the cluster to one set of associated bounding boxes corresponding to a detected person based on the ground point of the bounding box at block 606 in some embodiments comprises one or more of: (i) for a first pair of camera views comprising a first camera view obtained from a first camera and a second camera view obtained from a second camera, wherein the first camera view and the second camera view include ground points within a cluster, associating a first bounding box from the cluster in the first camera view with a second bounding box from the cluster in the second camera view by using a Hungarian algorithm approach based on Euclidean distances between ground points of the bounding boxes in the first camera view and ground points of the bounding boxes in the second camera view; (ii) for a second pair of camera views comprising a third camera view obtained from a third camera and a fourth camera view obtained from a fourth camera, wherein the third camera view and the fourth camera view include ground points within the cluster, associating a first bounding box from the cluster in the third camera view with a second bounding box from the cluster in the fourth camera view by using the Hungarian algorithm approach based on Euclidean distances between ground points of the bounding boxes in the third camera view and ground points of the bounding boxes in the fourth camera view; (iii) generating a first set of composite ground points, wherein each composite ground point in the first set of composite ground points is based on an average of two ground points of two bounding boxes from the cluster from the first camera view and the second camera view; (iv) generating a second set of composite ground points, wherein each composite ground point in the second set of composite ground points is based on an average of two ground points of two bounding boxes from the cluster from the second camera view and the third camera view; and (v) associating composite ground points in the first set of composite ground points with ground points in the second set of composite ground points by using the Hungarian algorithm approach based on Euclidean distances between the composite ground points in the first set of composite ground points and the ground points in the second set of composite ground points.

Next, method 600 advances to block 608, which includes for each timeframe of a plurality of timeframes, (i) generating a bounding cuboid for each set of associated bounding boxes for the timeframe, and (ii) for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views.

In some embodiments, the step of, for each timeframe of a plurality of timeframes, generating a bounding cuboid for each set of associated bounding boxes for the timeframe comprises, for each set of associated bounding boxes for the timeframe at block 608 includes: (i) for every bounding box in the set of associated bounding boxes, generating a point at each corner of the bounding box; and (ii) generating a bounding cuboid corresponding to the set of associated bounding boxes that encloses substantially all of the points at each corner of all of the bounding boxes within the set of associated bounding boxes. In some embodiments, generating a bounding cuboid corresponding to the set of associated bounding boxes that encloses substantially all of the points at each corner of all of the bounding boxes within the set of associated bounding boxes comprises: (i) estimating a centroid for the set of associated bounding boxes by triangulating mid-points from all of the bounding boxes within the set of associated bounding boxes; (ii) back-projecting all four corners of each bounding box within the set of associated bounding boxes onto a plane perpendicular to a camera view intersecting at the estimated centroid; and (iii) generating the bounding cuboid based on the back-projected corners and the estimated centroids.

In some embodiments, the step of, for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views at block 608 includes: (i) creating one or more cuboid groups, where an individual cuboid group contains two or more generated bounding cuboids that have centroids within a threshold distance of each other; and (ii) within each cuboid group, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets.

In some embodiments, the step of, within each cuboid group, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets at block 608 includes: associating each generated bounding cuboid within the cuboid group with a tracklet in the plurality of tracklets by using a Hungarian algorithm approach based on Euclidean distances between centroids of the bounding cuboids in cuboid group and predicted centroids for each tracklet in the plurality of tracklets.

Some embodiments of method 600 additionally include for each tracklet in the plurality of tracklets, using a Kalman filter to generate the predicted future positions for each of the plurality of tracklets for the timeframe, where each tracklet corresponds to a set of historical cuboids of one of the persons detected in the plurality of camera views.

In some such embodiments, the Kalman filter is configured to, for each tracklet in the plurality of tracklets: (i) assume acceleration of the person within the plurality of timeframes is constant; and (ii) treat a time derivative of acceleration and a third moment of position in each timeframe of the plurality of timeframes as noise. The time derivative of acceleration and a third moment of position in each timeframe of the plurality of timeframes is sometimes referred to as jerk.

In some embodiments that employ Kalman filtering techniques, the Kalman filter comprises a third degree Kalman filter with eighteen dimensional states, wherein the eighteen dimensional states comprise (i) six coordinates that define a bounding cuboid corresponding to a person, (ii) six coordinates that define velocity of the bounding cuboid corresponding to the person, and (iii) six coordinates that define acceleration of the bounding cuboid corresponding to the person.

In some embodiments of method 600, the environment is a sports environment and the persons include players and/or other persons within the sports environment (e.g., coaches, umpires or referees, linemen, and so on). In some such embodiments, method 600 additionally includes for each player detected within the video data, identifying a role of the player by mapping an initial position of the player within the sports environment to a particular region within the sports environment. And some embodiments of method 600 additionally include for at least one player, correlating the player with the data associated with the player, wherein the data associated with the player includes game statistics associated with the player.

FIG. 6B shows aspects of an example method 610 for tracking objects in an environment according to some embodiments. In operation, method 610 is performed for each detected object that has been detected by n cameras within an environment.

Method 610 begins at step 612, which includes generating a point cloud that includes a plurality of points, wherein each point of the plurality of points corresponds to a point in space where two rays projected from two of the plurality of cameras intersect the detected object.

Next, method 610 advances to step 614, which includes creating a selected subset of the plurality of points, wherein the selected subset of the plurality of points includes points that are within a threshold distance of a threshold number of other points of the plurality of points.

Next, method 610 advances to step 616, which includes generating a cuboid associated with the detected object, wherein the cuboid is based on a centroid of the points in the selected subset of points.

Next, method 610 advances to step 618, which includes matching the generated cuboid associated with the detected object with one of a plurality of object tracklets, wherein each object tracklet corresponds to a tracked object, and wherein matching the generated cuboid associated with the detected object with one of the plurality of object tracklets is based on distances between (i) a position of a centroid of the generated cuboid associated with the detected object, and (ii) positions of predicted centroids for each object tracklet in the plurality of object tracklets.

### IX. Example Computing Systems

FIG. 7 shows an example computing system 700 configured for implementing one or more (or all) aspects of the methods and processes disclosed herein.

Computing system 700 includes one or more processors 702, one or more tangible, non-transitory computer-readable memory/media 704, one or more user interfaces 706, and one or more network interfaces 708.

The one or more processors 702 may include any type of computer processor now known or later developed that is suitable for performing one or more (or all) of the disclosed features and functions, individually or in combination with one or more additional processors

The one or more tangible, non-transitory computer-readable memory/media 704 is configured to store program instructions that are executable by the one or more processors 702. The program instructions, when executed by the one or more processors 702 cause the computing system to perform any one or more (or all) of the functions disclosed and described herein. In operation, the one or more tangible, non-transitory computer-readable memory/media 704 is also configured to store data that is used in connection with both (i) performing the disclosed functions and (ii) generated via performing the disclosed functions.

The one or more user interfaces 706 may include any one or more of a keyboard, monitor, touchscreen, mouse, trackpad, voice interface, or any other type of user interface now known or later developed that is suitable for receiving inputs from a computer user or another computer and/or providing outputs to a computer user or another computer.

The one or more network interfaces 708 may include any one or more wired and/or wireless network interfaces, including but not limited to Ethernet, optical, WiFi, Bluetooth, or any other network interface now known or later developed that is suitable for enabling the computing system 700 to receive data from other computing devices and systems and/or transmit data to other computing devices and systems.

The computing system 700 corresponds to any one or more of a desktop computer, laptop computer, tablet computer, smartphone, and/or computer server acting individually or in combination with each other to perform the disclosed features.

### X. Conclusions

Although the present invention has been described and illustrated with respect to preferred embodiments and preferred uses thereof, it is not to be so limited since modifications and changes can be made therein which are within the full, intended scope of the invention as understood by those skilled in the art.

What is claimed is:

1. A method of tracking persons in an environment, the method comprising:
obtaining a plurality of camera views from a corresponding plurality of cameras positioned at different locations around the environment and configured to obtain frames of video data containing persons within the environment;
for each camera view obtained from an individual camera, (i) detecting one or more persons within the camera view by processing the video data from the individual camera via a neural network, and (ii) generating a bounding box for each person detected in the camera view;
generating one or more sets of associated bounding boxes, wherein each set of associated bounding boxes includes two or more bounding boxes from two or more different camera views that correspond to a same person detected in the different camera views; and
for each timeframe of a plurality of timeframes, (i) generating a bounding cuboid for each set of associated bounding boxes for the timeframe, and (ii) for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views.

2. The method of claim 1, wherein for each camera view obtained from an individual camera, detecting one or more persons within the camera view by processing the video data from the individual camera via a neural network comprises:
for frames of video data obtained from an individual camera, generating input tensor data based on an anchor frame selected from the frames of video data obtained from the individual camera;
detecting the one or more persons via the neural network based on the input tensor data; and
generating output tensor data corresponding to each person detected within the anchor frame.

3. The method of claim 2, wherein for each camera view obtained from an individual camera, generating a bounding box for each person detected in the camera view comprises:
for each person detected within the anchor frame, generating the bounding box corresponding to the person detected within the anchor frame based on the output tensor data corresponding to the person detected within the anchor frame.

4. The method of claim 2, wherein for each camera view obtained from an individual camera, generating a bounding box for each person detected in the camera view comprises:
when the camera view includes two or more persons, and when the neural network has generated a set of bounding boxes comprising two or more bounding boxes for each detected person, applying a non-max suppression filtering process with an Intersection over Minimum Area (IoMA) metric to the set of bounding boxes.

5. The method of claim 2, wherein for each camera view obtained from an individual camera, generating a bounding box for each person detected in the camera view comprises, when the camera view includes two or more persons, and when the neural network has generated a set of bounding boxes comprising two or more bounding boxes for each detected person:
when an individual camera view includes an object that at least partially obstructs the individual camera's view of one or more persons, applying a non-max suppression filtering process with an Intersection over Minimum Area (IoMA) metric to the set of bounding boxes; and
when the individual camera view does not include an object that at least partially obstructs the individual camera's view of one or more persons, applying a non-max suppression filtering process with an Intersection over Union (IoU) metric to the set of bounding boxes.

6. The method of claim 1, wherein generating one or more sets of associated bounding boxes comprises:
for each bounding box in each camera view, generating a ground point for the bounding box that corresponds to a point on a ground plane of the environment where a ray projected from the camera that obtained the camera view intersects a midpoint along a bottom of the bounding box.

7. The method of claim 6, wherein generating one or more sets of associated bounding boxes further comprises:
mapping ground points corresponding to bounding boxes in each of the camera views to a graph within the ground plane;
performing a connected components analysis on the ground points to identify clusters of ground points, wherein an individual cluster includes ground points within a threshold distance of each other on the ground plane; and
within each cluster, assigning each bounding box in the cluster to one set of associated bounding boxes corresponding to a detected person based on the ground point of the bounding box.

8. The method of claim 7, wherein within each cluster, assigning each bounding box in the cluster to one set of associated bounding boxes corresponding to a detected person based on the ground point of the bounding box comprises:
for a first pair of camera views comprising a first camera view obtained from a first camera and a second camera view obtained from a second camera, wherein the first camera view and the second camera view include ground points within a cluster, associating a first bounding box from the cluster in the first camera view with a second bounding box from the cluster in the second camera view by using a Hungarian algorithm approach based on Euclidean distances between ground points of the bounding boxes in the first camera view and ground points of the bounding boxes in the second camera view.

9. The method of claim 8, wherein within each cluster, assigning each bounding box in the cluster to one set of associated bounding boxes based on the ground point of the bounding box further comprises:
for a second pair of camera views comprising a third camera view obtained from a third camera and a fourth camera view obtained from a fourth camera, wherein the third camera view and the fourth camera view include ground points within the cluster, associating a first bounding box from the cluster in the third camera view with a second bounding box from the cluster in the fourth camera view by using the Hungarian algorithm approach based on Euclidean distances between ground points of the bounding boxes in the third camera view and ground points of the bounding boxes in the fourth camera view;
generating a first set of composite ground points, wherein each composite ground point in the first set of composite ground points is based on an average of two ground points of two bounding boxes from the cluster from the first camera view and the second camera view;
generating a second set of composite ground points, wherein each composite ground point in the second set of composite ground points is based on an average of two ground points of two bounding boxes from the cluster from the second camera view and the third camera view; and
associating composite ground points in the first set of composite ground points with ground points in the second set of composite ground points by using the Hungarian algorithm approach based on Euclidean distances between the composite ground points in the first set of composite ground points and the ground points in the second set of composite ground points.

10. The method of claim 1, wherein for each timeframe of a plurality of timeframes, generating a bounding cuboid for each set of associated bounding boxes for the timeframe comprises:
for every bounding box in the set of associated bounding boxes, generating a point for each corner of the bounding box; and
generating a bounding cuboid corresponding to the set of associated bounding boxes that encloses substantially all of the points at each corner of all of the bounding boxes within the set of associated bounding boxes, wherein generating a bounding cuboid corresponding to the set of associated bounding boxes that encloses substantially all of the points at each corner of all of the bounding boxes within the set of associated bounding boxes comprises:
estimating a centroid for the set of associated bounding boxes by triangulating mid-points from all of the bounding boxes within the set of associated bounding boxes;
back-projecting all four corners of each bounding box within the set of associated bounding boxes onto a plane perpendicular to a camera view intersecting at the estimated centroid; and
generating the bounding cuboid based on the back-projected corners and the estimated centroids.

11. The method of claim 1, wherein for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views which comprises:
creating one or more cuboid groups, wherein an individual cuboid group contains two or more generated bounding cuboids that have centroids within a threshold distance of each other; and
within each cuboid group, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets.

12. The method of claim 11, wherein within each cuboid group, assigning each generated bounding cuboid in the cuboid group to one tracklet of the plurality of tracklets based on distances between (i) positions of centroids of the generated bounding cuboids in the cuboid group, and (ii) positions of predicted centroids for each tracklet in the plurality of tracklets comprises:
associating each generated bounding cuboid within the cuboid group with a tracklet in the plurality of tracklets by using a Hungarian algorithm approach based on Euclidean distances between centroids of the bounding cuboids in cuboid group and predicted centroids for each tracklet in the plurality of tracklets.

13. The method of claim 1, further comprising:
for each tracklet in the plurality of tracklets, using a Kalman filter to generate the predicted future positions for each of the plurality of tracklets for the timeframe, wherein each tracklet corresponds to a set of historical cuboids of one of the persons detected in the plurality of camera views.

14. The method of claim 13, wherein the Kalman filter is configured to, for each tracklet in the plurality of tracklets:
assume acceleration of the person within the plurality of timeframes is constant; and
treat a time derivative of acceleration and a third moment of position in each timeframe of the plurality of timeframes as noise.

15. The method of claim 13, wherein the Kalman filter comprises a third degree Kalman filter with eighteen dimensional states, wherein the eighteen dimensional states comprise (i) six coordinates that define a bounding cuboid corresponding to a person, (ii) six coordinates that define velocity of the bounding cuboid corresponding to the person, and (iii) six coordinates that define acceleration of the bounding cuboid corresponding to the person.

16. The method of claim 1, wherein the neural network comprises an anchor-free, single-stage object detector.

17. The method of claim 1, wherein the environment is a sports environment, wherein the persons include players, and wherein the method further comprises:
for each player detected within the video data, identifying a role of the player by mapping an initial position of the player within the sports environment to a particular region within the sports environment.

18. The method of claim 17, further comprising:
for at least one player, correlating the player with the data associated with the player, wherein the data associated with the player includes game statistics associated with the player.

19. The method of claim 1, further comprising tracking one or more objects detected within the environment, wherein tracking the one or more detected objects comprises, for each detected object that has been detected by the plurality of cameras:
generating a point cloud that includes a plurality of points, wherein each point of the plurality of points corresponds to a point in space where two rays projected from two of the plurality of cameras intersect the detected object;
creating a selected subset of the plurality of points, wherein the selected subset of the plurality of points includes points that are within a threshold distance of a threshold number of other points of the plurality of points;
generating a cuboid associated with the detected object, wherein the cuboid is based on a centroid of the points in the selected subset of points; and
matching the generated cuboid associated with the detected object with one of a plurality of object tracklets, wherein each object tracklet corresponds to a tracked object, and wherein matching the generated cuboid associated with the detected object with one of the plurality of object tracklets is based on distances between (i) a position of a centroid of the generated cuboid associated with the detected object, and (ii) positions of predicted centroids for each object tracklet in the plurality of object tracklets.

20. Tangible, non-transitory computer-readable media comprising program instructions, where the program instructions, when executed by one or more processors, cause a computing system to perform functions comprising:
obtaining a plurality of camera views from a corresponding plurality of cameras positioned at different locations around an environment and configured to obtain frames of video data containing persons within the environment;
for each camera view obtained from an individual camera, (i) detecting one or more persons within the camera view by processing the video data from the individual camera via a neural network, and (ii) generating a bounding box for each person detected in the camera view;
generating one or more sets of associated bounding boxes, wherein each set of associated bounding boxes includes two or more bounding boxes from two or more different camera views that correspond to a same person detected in the different camera views; and
for each timeframe of a plurality of timeframes, (i) generating a bounding cuboid for each set of associated bounding boxes for the timeframe, and (ii) for each generated bounding cuboid, associating the generated bounding cuboid with one of a plurality of tracklets for the timeframe based on (a) a position of the generated bounding cuboid during the timeframe and (b) predicted future positions for each of the plurality of tracklets for the timeframe, wherein each tracklet corresponds to a set of historical positions of one of the persons detected in the plurality of camera views.
